(19) United States
(12) Patent Application Publication
(10) Pub. No.: US 2026/0367867 A1
(43) Pub. Date: Nov. 19, 2026

(54) Live Multimodal Generative Chat Interface

(71) Applicant: Google LLC, Mountain View, CA (US)

(72) Inventors: Jessica Lee, Brooklyn, NY (US); Clement Dickinson Wright, Los Angeles, CA (US); Harshit Kharbanda, Pleasanton, CA (US); Wewage Anuda Nethum Dep Weerasinghe, San Francisco, CA (US); Kai Yu, San Francisco, CA (US); Louis Wang, San Francisco, CA (US); Stacy Lou Chiou, Los Angeles, CA (US); Sarah Fay Smith, San Francisco, CA (US); Christopher James Kelley, Orinda, CA (US); David Kao-Chun Wu, Forest Hills, NY (US); Christophe Patrice Fondacci, Daly City, CA (US); Liza Sol Wah Ma, Los Altos, CA (US); Olawale Abiri, Westfield, NJ (US); Kimiya Hojjat, Oakland, CA (US)

(21) Appl. No.: 19/660,591

(22) Filed: Apr. 28, 2026

Related U.S. Application Data
(60) Provisional application No. 63/806,455, filed on May 15, 2025.

(51) Int. Cl. G06F 3/16; G06F 3/0482; G06F 16/438; H04L 51/10; G06V 30/10

(52) U.S. Cl. CPC G06F 3/167; G06F 3/0482; G06F 16/438; H04L 51/10; G06V 30/10

(57) ABSTRACT

Systems and methods for providing a multimodal video chat interface can obtain data descriptive of an audio stream and an image stream, can process the audio stream and image stream to generate a model-generated query, can determine search results responsive to the model-generated query, and can generate a model-generated response based on the search results. The model-generated response can be provided via an audio output while search results may be provided as a visual notification. The image stream may include a plurality of screen capture frames.

### PRIORITY CLAIM

The present application is based on and claims priority to United States Provisional Application Number 63/806,455 having a filing date of May 15, 2025. Application claims priority to and the benefit of each of such application and incorporates all such applications herein by reference in their entirety.

### FIELD

The present disclosure relates generally to artificial intelligence multimodal video chat interface. More particularly, the present disclosure relates to providing a multimodal video chat interface that provides real-time multimodal data processing to respond to user questions with chat context awareness.

### BACKGROUND

Understanding the world at large can be difficult. Whether an individual is trying to understand what the object in front of them is, trying to determine where else the object can be found, and/or trying to determine where an image on the internet was captured from, text searching alone can be difficult. In particular, users may struggle to determine which words to use. Additionally, the words may not be descriptive enough and/or abundant enough to generate desired results. Existing visual question and answering task entry points may fail to be intuitive.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system including one or more processors, a user request to invoke a multimodal chat interface from a user computing device. The method can include obtaining, by the computing system, an image stream from the user computing device. The image stream can include a plurality of image frames. The method can include obtaining, by the computing system, an audio stream from the user computing device. The audio stream can include audio data obtained via one or more audio sensors of the user computing device. The method can include processing, by the computing system, at least a portion of the image stream and at least a portion of the audio stream with a generative model to generate a model-generated query. The method can include determining, by the computing system, one or more search results based on the model-generated query and processing, by the computing system, one or more search results and the model-generated query with the generative model to generate a model-generated response. The method can include providing, by the computing system, the model-generated response via an audio playback of the user computing device.

In some implementations, the method can include providing, by the computing system, a search result notification overlaid over the image stream of the user computing device. The search result notification can include an indication of the one or more search results.

In some implementations, the method can include providing, by the computing system, a voice call interface before obtaining the user request to invoke the multimodal chat interface. The voice call interface can be configured to receive audio data via the one or more audio sensors of the user computing device and provide one or more predicted responses for output via at least one of a screen of the user computing device or one or more speakers of the user computing device. The method can include obtaining, by the computing system and via the voice call interface, a voice command. The voice command can include a unimodal query. The method can include processing, by the computing system, the voice command with the generative model to generate a model-generated predicted response to the unimodal query and providing, by the computing system, the model-generated predicted response via the audio playback of the user computing device using the one or more speakers. The generative model can generate the model-generated predicted response based on one or more information data calls to one or more external tools.

In some implementations, the method can include obtaining, by the computing system, a selection of an interface element of the search result notification and providing, by the computing system, a web resource associated with the one or more search results for display. The multimodal chat interface can transition to a voice call interface. Transitioning can include stopping image stream collection and continuing audio stream collection.

In some implementations, the method can include obtaining, by the computing system, a selection of an interface element of the search result notification and providing, by the computing system, a web resource associated with the one or more search results for display. The multimodal chat interface can transition from camera capture to screen capture. Transitioning can include stopping image stream collection via one or more image sensors of the user computing device, beginning screen capture via an overlay interface of the multimodal chat interface, and continuing audio stream collection. The method can include obtaining, by the computing system, a follow-up query. The follow-up query can be associated with display content on the user computing device. The method can include obtaining, by the computing system, one or more screen capture frames and processing, by the computing system, the follow-up query and the one or more screen capture frames with the generative model to generate a model-generated follow-up response. The model-generated follow-up response can be responsive to the follow-up query. The method can include providing, by the computing system, the model-generated follow-up response via the audio playback of the user computing device.

In some implementations, processing, by the computing system, at least the portion of the image stream and at least the portion of the audio stream with the generative model to generate the model-generated query can include processing between three to five minutes of image frames.

In some implementations, processing, by the computing system, at least the portion of the image stream and at least the portion of the audio stream with the generative model to generate the model-generated query can include variably sampling frames of the image stream. A sampling rate of variably sampling can be based on performing pixel diffing associated with border pixels of the plurality of image frames.

Another example aspect of the present disclosure is directed to a computing system. The system can include one or more processors and one or more non-transitory computer-readable media that collectively store instructions that, when executed by the one or more processors, cause the computing system to perform operations. The operations can include providing a voice call interface. The voice call interface can be configured to receive audio data via the one or more audio sensors of a user computing device and provide one or more predicted responses for output via one or more output components of the user computing device. The voice call interface can provide multimodal call options via selectable user interface elements. The multimodal call options can include a viewfinder multimodal chat interface and a screensharing multimodal chat interface. In some implementations, the viewfinder multimodal chat interface can be configured to receive viewfinder image data via one or more image sensors of the user computing device and audio data via the one or more audio sensors of the user computing device and providing one or more predicted responses for output via the one or more output components of the user computing device. In some implementations, the screensharing multimodal chat interface can be configured to receive screen capture image data via a screen capture overlay interface of the user computing device and audio data via the one or more audio sensors of the user computing device and providing one or more predicted responses for output via the one or more output components of the user computing device. The operations can include obtaining a selection of a particular multimodal call option associated with the screensharing multimodal chat interface. The operations can include obtaining, via the overlay interface, a screen capture stream from the user computing device. The screen capture stream can include a plurality of image frames descriptive of display content provided for display on the user computing device. The operations can include obtaining an audio stream from the user computing device. The audio stream can include audio data obtained via the one or more audio sensors of the user computing device. The operations can include processing at least a portion of the screen capture stream and at least a portion of the audio stream with a generative model to generate a model-generated response and providing the model-generated response via an audio playback of the user computing device.

In some implementations, processing at least the portion of the screen capture stream and at least the portion of the audio stream with the generative model to generate the model-generated response can include processing at least the portion of the screen capture stream and at least the portion of the audio stream with the generative model to generate a model-generated query, determining one or more search results based on the model-generated query, and processing one or more search results and the model-generated query with the generative model to generate the model-generated response.

In some implementations, processing at least the portion of the screen capture stream and at least the portion of the audio stream with the generative model to generate the model-generated response can include processing one or more frames of the plurality of frames to generate a context dataset comprising details associated with features depicted in the one or more frames, processing at least the portion of the audio stream to generate text data descriptive of the audio data, and processing the context dataset and the text data with the generative model to generate the model-generated response. Generating the contextual dataset can include determining a plurality of object labels descriptive of a plurality of objects identified within the one or more frames. Generating the contextual dataset can include performing optical character recognition on the one or more frames.

In some implementations, the operations can include generating a multimodal transcript of a session including an audio transcript, search results, and relevant image frames. The audio transcript can include input voice commands and output model-generated responses. The search results may have been determined in response to receiving the input voice commands. The operations can include storing the multimodal transcript and providing the multimodal transcript for display.

Another example aspect of the present disclosure is directed to one or more non-transitory computer-readable media that collectively store instructions that, when executed by one or more computing devices, cause the one or more computing devices to perform operations. The operations can include obtaining a user request to invoke a screensharing multimodal chat interface from a user computing device. The operations can include obtaining, via an overlay interface, a screen capture stream from the user computing device. The screen capture stream can include a plurality of image frames descriptive of display content provided for display on the user computing device. The operations can include obtaining an audio stream from the user computing device. The audio stream can include audio data obtained via one or more audio sensors of the user computing device. The operations can include processing at least a portion of the screen capture stream and at least a portion of the audio stream with a generative model to generate a model-generated query and determining one or more search results based on the model-generated query. The operations can include processing one or more search results and the model-generated query with the generative model to generate a model-generated response. The operations can include providing the model-generated response via an audio playback of the user computing device and providing, during audio playback, an audio output indicator overlaid over a portion of the display content.

In some implementations, the overlay interface can continue to obtain data descriptive of the screen capture stream during the display of the audio output indicator. The overlay interface can capture the plurality of image frames above a display content interface layer and below an indicator interface layer that displays the audio output indicator to provide for full display content capture even when the audio output indicator is provided for display.

In some implementations, the operations can include processing a frame of the plurality of frames of the screen capture stream to determine the display content is part of a particular web resource and obtaining a full content item associated with the particular web resource. The full content item can include the display content. At least one of the model-generated query or the model-generated response can be determined based on the full content item. In some implementations, obtaining the full content item can include identifying a uniform resource locator associated with the particular web resource and at least one of obtaining source code data for the particular web resource or obtaining a document associated with the particular web resource.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example multimodal live chat interface system according to example embodiments of the present disclosure.

FIG. 2 depicts a block diagram of an example artificial intelligence chat system according to example embodiments of the present disclosure.

FIG. 3 depicts a flow chart diagram of an example method to perform multimodal chat processing according to example embodiments of the present disclosure.

FIGS. 4A – 4C depict illustrations of an example dynamic interface according to example embodiments of the present disclosure.

FIG. 5 depicts an illustration of an example screensharing chat notification interface according to example embodiments of the present disclosure.

FIGS. 6A – 6C depicts illustrations of an example interface flow according to example embodiments of the present disclosure.

FIG. 7 depicts a flow chart diagram of an example method to perform dynamic multilevel generative interfacing according to example embodiments of the present disclosure.

FIG. 8 depicts a flow chart diagram of an example method to perform screensharing chat processing according to example embodiments of the present disclosure.

FIG. 9A depicts a block diagram of an example computing system that performs live multimodal processing according to example embodiments of the present disclosure.

FIG. 9B depicts a block diagram of an example computing system that performs live multimodal processing according to example embodiments of the present disclosure.

FIG. 10 depicts a flow chart diagram illustrating an example method for training a machine-learned model according to example implementations of aspects of the present disclosure.

FIG. 11 depicts a block diagram of an example processing flow for using machine-learned model(s) to process input(s) to generate output(s) according to example implementations of aspects of the present disclosure.

FIG. 12 depicts a block diagram of an example sequence processing model according to example implementations of aspects of the present disclosure.

FIG. 13 depicts a block diagram of an example technique for populating an example input sequence for processing by a sequence processing model according to example implementations of aspects of the present disclosure.

FIG. 14 depicts a block diagram of an example model development platform according to example implementations of aspects of the present disclosure.

FIG. 15 depicts a block diagram of an example training workflow for training a machine-learned model according to example implementations of aspects of the present disclosure.

FIG. 16 depicts a block diagram of an inference system for operating one or more machine-learned model(s) to perform inference according to example implementations of aspects of the present disclosure.

FIG. 17 depicts a block diagram of an example networked computing system according to example implementations of aspects of the present disclosure.

FIG. 18 depicts a block diagram of an example computing device according to example implementations of aspects of the present disclosure.

FIG. 19 depicts a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for providing a multimodal video chat interface. In particular, the systems and methods disclosed herein can leverage audio processing, image processing, overlay application screen capture, and/or user interface elements to provide a continuous multimodal visual question and answering system. The systems and methods can include a plurality of options for interfacing with a generative agent system that includes a large language model configured to interface with external tools and cache chat context in order to respond to user chat instances. The plurality of options can include a unimodal voice call option, a viewfinder multimodal call option, and/or a screensharing multimodal call option. The unimodal voice call option can include obtaining and processing audio data to provide outputs via audio output and/or visual screen outputs on a screen of the computing device. The viewfinder multimodal call option can include obtaining and processing audio data and image data from image sensors of a computing device to provide outputs via audio output and/or visual screen outputs on the screen of the computing device by overlaying the notifications and indicators over the viewfinder images. The screensharing multimodal call option can include obtaining and processing audio data and image data from screen capture of the computing device to provide outputs via audio output and/or visual screen outputs on the screen of the computing device.

The multimodal chat interface can obtain an audio stream descriptive of audio data captured via one or more audio sensors of a user computing device. The audio data can include one or more voice commands including questions and/or comments. The multimodal chat interface can obtain an image stream descriptive of a plurality of sequential frames obtained via one or more image sensors and/or an overlay interface of the user computing device. The audio stream and the image stream can be processed with a generative model to generate a model-generated query. The model-generated query can be processed to determine one or more search results. The generative model can process the model-generated query and the one or more search results to generate a model-generated response. The multimodal chat interface can provide the model-generated response for output via an audio playback utilizing one or more speakers of the user computing device. In some implementations, the multimodal chat interface may provide a result notification that provides the one or more search results for display.

In some implementations, the image frame capture rate and/or the image frame processing rate (e.g., the temporal rate of selecting and processing a frame) can be variable based on performing pixel diffing and/or based on the rate of detected human speech. For example, if the pixels of the image frame borders have relatively little change from frame to frame the capture rate and/or the processing rate may be decreased, while constant pixel change may cause the capture rate and/or the processing rate to be increased. Additionally and/or alternatively, if speech is constantly detected, the capture rate and/or the processing rate may increase, while seldom speech detection may cause a decrease in the capture rate and/or the processing rate.

In some implementations, the multimodal chat interface may keep a chat log that may include past voice commands, past relevant image frames, past search results, and/or past model-generated responses. The generative model may process the context to generate a context summary and/or a context representation that can be leveraged for future model-generated response generation instances.

A multimodal artificial intelligence agent call system can allow a user to ask questions about the content currently provided for display and/or the environment around the user. The interface may include a unimodal voice call option, a screensharing multimodal call option, and/or a viewfinder multimodal call option. The multimodal artificial intelligence agent call system may be implemented by a virtual assistant application and/or an extension. The multimodal artificial intelligence agent call system may be performed with and/or in combination with a smart wearable, a mobile computing device, and/or other computing device.

Understanding the world at large can be difficult. Whether an individual is trying to understand what the object in front of them is, trying to determine where else the object can be found, and/or trying to determine where an image on the internet was captured from, text searching alone can be difficult. In particular, users may struggle to determine which words to use. Additionally, the words may not be descriptive enough and/or abundant enough to generate desired results. Existing visual question and answering task entry points may fail to be intuitive.

A multimodal artificial intelligence agent call system can provide an intuitive interface for a user to ask questions about their environment and/or content currently provided for display on their screen. In particular, the multimodal artificial intelligence agent call system may include a call interface that emulates a video call. The multimodal artificial intelligence agent call system can leverage audio processing, image processing, overlay application screen capture, and/or user interface elements to provide a continuous multimodal visual question and answering system. The system can include summarizing context associated with previous interactions in the session and may include variable frame capture to reduce latency while still providing contextually-aware responses.

The user interface can provide for unimodal (e.g., audio only) search and multiple different types of multimodal search capabilities. Overlay screen capture and document retrieval can provide for visual questioning and answering for display content while using the video call interface. The system can compress and/or summarize previous audio and visual context, which can allow for the session context to be utilized in response prediction with reduced latency. Additionally and/or alternatively, computational cost and latency may be reduced based on the use of pixel diffing to determine the frame capture rate such that low dynamic sequences may lead to a lower frame capture rate.

In some implementations, the user can annotate the screen (e.g., with a mouse or a finger) (e.g., circling objects etc.). The systems and methods disclosed herein can obtain the audio stream, the image stream, and a gesture input. One or more image frames can be segmented based on the gesture input to generate an image segment. The audio stream can be processed to identify a voice command descriptive of a query (e.g., a question). The query can be transcribed into a text query. The text query and the image segment can then be processed to generate the model-generated response. Alternatively and/or additionally, the gesture input can be processed to generate an attention map for one or more image frames of the image stream. The text query, the attention map(s), and the one or more image frames can then be processed with the generative model to generate the model-generated query and/or the model-generated response.

Alternatively and/or additionally, the systems and methods may utilize gaze detection to understand where on the screen the user is looking. The gaze detection may be utilized to generate the image segment and/or generate the attention map. The gaze detection may include obtaining a second image stream descriptive of a user’s eyes. The second image stream can be processed with a machine-learned gaze detection model to determine a point of focus.

The systems and methods can utilize a plurality of different output types for providing the one or more search results and/or the model-generated response. The outputs can include audio outputs for audio playback including reciting the model-generated response. The outputs may include annotating the displayed content and/or one or more other image frames of the image stream based on the one or more search results and/or the model-generated response. The annotated frames and/or annotated live feed may be provided for display to the user via a screen of the user computing device. The annotations can include highlighting, arrows, diagrams, shape overlays, screen contrasts, text overlays, and/or other annotations.

In some implementations, the systems and methods may provide “take control” optionality in which the system may provide the user with the optionality to allow the system to “take control” (e.g., perform interface auto-navigations, highlights, selections, and/or other actions) of the interface and/or the user computing device. For example, the model-generated response may include a set of actions to be performed based on the user voice command and/or may have grounding in content within the displayed content (e.g., the system can then show the grounding source content via a “Here let me show you how.”). In response to the model-generated response including a set of actions to be performed, the system may provide an option to the user to allow for the system to perform these actions in front of the user (e.g., “Here let me show you how.”) and/or in place of the user.

In some implementations, model-generated content (e.g., portions and/or all of the model-generated response) may be inserted into text fields or other data fields of existing user interface (e.g., “Sure I can fill out this form for you.”). The model-generated response may include application programming interface calls and/or tool calls for performing actions to interface with one or more external resources (e.g., web pages and/or other interfaces or tools). In some implementations, the model-generated response may be processed with an image generation model to generate a model-generated image. The model-generated image may then be provided for display and/or may be utilized to augment content currently provided for display on the user computing device.

In some implementations, the model-generated response may include one or more predicted actions that can then be provided as selectable options that may automate the given predicted action. The one or more predicted actions may include translation, image augmentation, auto-navigation, homework solver, and/or other selectable actions to be performed.

In some implementations, the audio stream may include a first audio stream and a second audio stream. The first audio stream can include audio obtained via a microphone of a user computing device. The second audio stream can include audio queued for playback on the user computing device.

The systems and methods disclosed herein can include a conversational artificial intelligence system that can function like a real-time audio or video call with an intelligent agent. This system can be designed to process multiple inputs simultaneously, and can combine a user’s spoken query from an audio stream with a visual stream from a device’s camera or screen capture. A generative model at the core of the system may interpret these multimodal inputs to understand a user’s request, identify relevant information, and generate a comprehensive response that can be delivered back to the user, typically through audio playback.

A user’s interaction can begin with a voice-only call, similar to a virtual assistant experience. From there, the user can seamlessly transition into a multimodal session by enabling their camera for a “viewfinder” mode or by activating screen sharing. This can allow the user to ask questions about physical objects in their environment or digital content on their screen. The system can provide responses not only through spoken audio but also with visual notifications, such as interactive “chips” containing source links, which can be overlaid on the user’s display to corroborate the AI’s answer.

Upon receiving concurrent audio and image streams, the generative model can analyze the combined context. To provide accurate and current information, the model can generate and execute its own queries to external tools, such as a web search engine. For instance, when analyzing a shared screen, the system can access the full content of a webpage or document, not just the visible portion. It may then synthesize the information from these external sources with the user’s original query to formulate a final, context-aware response.

To ensure efficiency and responsiveness, the system can employ several key technical optimizations. To reduce latency and computational load, the system can utilize a variable frame sampling rate, which can dynamically adjust based on the amount of change in the visual stream. For managing long conversations, a hybrid context system can retain a high-fidelity record of recent interactions while creating compressed, textual summaries of older visual context. Furthermore, during screen sharing, a layered interface architecture can ensure that the system’s own on-screen indicators are not captured, which can preserve the integrity of the visual data sent to the model for analysis.

The systems and methods can address the limitations of traditional text-based search by enabling users to conversationally explore and ask questions about their visual surroundings. Practical applications can include getting guided instructions for a physical task like troubleshooting an appliance, performing on-the-fly comparison shopping across browser tabs, or summarizing complex on-screen documents. By emulating a live video call with a context-aware AI, the system can provide a more natural and powerful way for users to bridge the gap between their physical or digital environment and the information they seek.

The systems and methods of the present disclosure provide a number of technical effects and benefits. As one example, the system and methods can provide a multimodal chat interface for search and/or other data processing tasks. In particular, the systems and methods disclosed herein can leverage audio processing, image processing, natural language processing, variable frame rate capture, screen capture, context summary generation, and/or user interface features to provide an interactive multimodal video call interface for real-time visual question and answering.

Another technical benefit of the systems and methods of the present disclosure is the ability to leverage one or more machine-learned models to understand an environment and provide a step by step process for completing a task and/or responding to a user query. For example, the systems and methods can determine the semantics of an environment and/or display content, can determine a prompt and/or query associated with the environment/display content, can determine a model-generated response associated with the prompt, and can continually collect data to respond to follow-up queries.

Another example of technical effect and benefit relates to improved computational efficiency and improvements in the functioning of a computing system. For example, the systems and methods disclosed herein can leverage variable frame capture rate based on pixel diffing, context summary generation, and/or context caching to reduce computational cost and/or latency for real-time multimodal processing and/or multimodal response generation.

Another technical benefit of the systems and methods of the present disclosure is the ability to provide visual search across a plurality of different surfaces provided by a computing device. In particular, the systems and methods disclosed herein can utilize a visual search interface in an operating system of a computing device to provide an overlay interface for data processing across a plurality of different surfaces (e.g., a plurality of different applications). The visual search interface can provide an overlay interface at the operating system level that can obtain and process data from a plurality of different applications, which may include generating and processing a screenshot of currently displayed content. The visual search interface can include on-device machine-learned models that can perform object detection, optical character recognition, segmentation, query suggestion, action suggestion, and/or other data processing tasks on-device without transmitting data to a server computing system. The on-device machine-learned models can provide privacy and can provide data processing services even when network access is limited and/or unavailable. The visual search interface can be implemented in a kernel of the operating system. Additionally and/or alternatively, the visual search kernel may include an interface (e.g., an application programming interface) for communicating with a server computing system to perform one or more additional data processing tasks (e.g., search engine processing, generative model media content generation, etc.).

Another technical benefit of the systems and methods of the present disclosure is the ability to leverage a visual search system that includes one or more communication interfaces for transmitting and obtaining data to a plurality of different applications. For example, the systems and methods disclosed herein can generate application programming interfaces and/or other communicative interfaces to perform data packet generation and transmittal and/or data calls. The systems and methods can process display data, generate one or more data processing outputs, and transmit data to a secondary application to perform one or more actions. Additionally and/or alternatively, data can be obtained from one or more secondary applications to generate one or more additional information content items. The operating system level system can leverage communicative interfaces to provide seamless use of data across different applications that may be utilized to transmit data packets to other users and/or generate (and/or aggregate) information for the user of the computing device. The operating system level implementation can be utilized to reduce upload and download instances and cost for a plurality of different processing tasks. Additionally and/or alternatively, temporary files and/or embeddings can be generated and processed to reduce storage usage and increase privacy budgeting.

Another example of technical effect and benefit relates to improved computational efficiency and improvements in the functioning of a computing system. For example, the systems and methods disclosed herein can leverage a visual search interface in the operating system to reduce the inputs and operations necessitated for performing particular data processing tasks across different applications. The reduction of inputs and operations can reduce the computational resources utilized to perform visual search, feature detection, and/or query and/or action suggestion based on processing display data. Additionally and/or alternatively, the operating system level visual processing system can utilize communicative interfaces to transmit and/or obtain data from secondary application(s), which can reduce the manual navigation, storage, and/or selection of a user.

With reference now to the Figures, example embodiments of the present disclosure will be discussed in further detail.

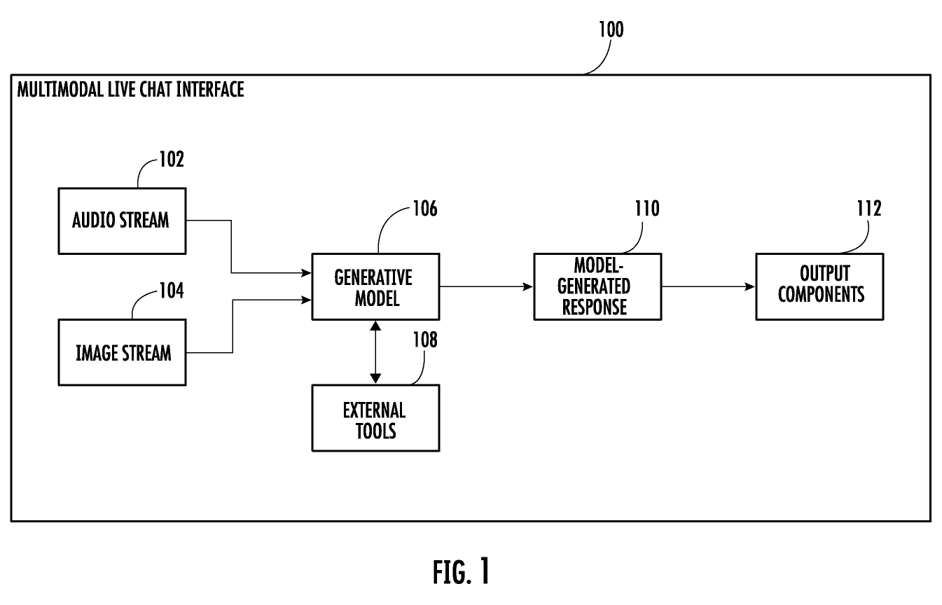

FIG. 1 depicts a block diagram of an example multimodal live chat interface system 100 according to example embodiments of the present disclosure. In some implementations, the multimodal live chat interface system 100 is configured to receive, and/or obtain, a set of input data including an audio stream 102 descriptive of audio data obtained with a user computing device and an image stream 104 descriptive of a plurality of live image frames obtained via screen capture and/or from image sensors on a user computing device and, as a result of receipt of the input data, generate, determine, and/or provide a model-generated response 110 that is responsive to one or more queries identified within the audio stream 102. Thus, in some implementations, the multimodal live chat interface system 100 can include a generative model 104 that is operable to process the input data, communicate with external tools 108, and generate the model-generated response 110.

In particular, the multimodal live chat interface system 100 can be configured to emulate a video call. The multimodal live chat interface system 100 can obtain and output audio data, while simultaneously obtaining and outputting visual data. For example, the multimodal live chat interface system 100 can obtain a live audio stream 102 from audio sensors communicatively connected with and/or part of a user computing device. The audio stream 102 may include audio data that includes one or more voice commands. The one or more voice commands can be descriptive of queries and/or prompts associated with visual features a user is currently viewing in their environment and/or on their screen. The multimodal live chat interface system 100 can obtain an image stream 104 that includes a plurality of frames descriptive of content provided for display on a user computing device and/or images generated with one or more image sensors communicatively connected with and/or part of a user computing device.

A generative model 106 can process the audio stream 102 and image stream 104 to generate a model-generated query and/or one or more external tool calls. The generative model 106 can transmit the model-generated query to one or more external tools 108 based on the one or more external tool calls. The one or more external tools 108 can process the model-generated query to generate one or more tool outputs that are then transmitted back to the generative model 106. The one or more external tools 108 can include a search engine, classification models, embedding models, image captioning models, transcription models, and/or other tools. The one or more tool outputs can include search results, classification labels, embeddings, image segments, text segments, and/or other outputs. The generative model can process the model-generated query and the one or more tool outputs to generate an updated model-generated query and updated tool calls to then perform another tool call loop until the generative model 106 has enough information to respond to the query of the audio stream 102.

Once enough information is obtained, the generative model 106 can process the model-generated query and the one or more tool outputs to generate a model-generated response 110. The model-generated response 110 can include a response to the one or more queries identified within the audio stream 102. The model-generated response 110 and/or the one or more tool outputs can then be provided as output via one or more output components 112 of a user computing device. The one or more output components 112 can include one or more speakers communicatively connected with and/or part of a user computing device. The one or more one or more output components 112 can include one or more screens communicatively connected with and/or part of a user computing device.

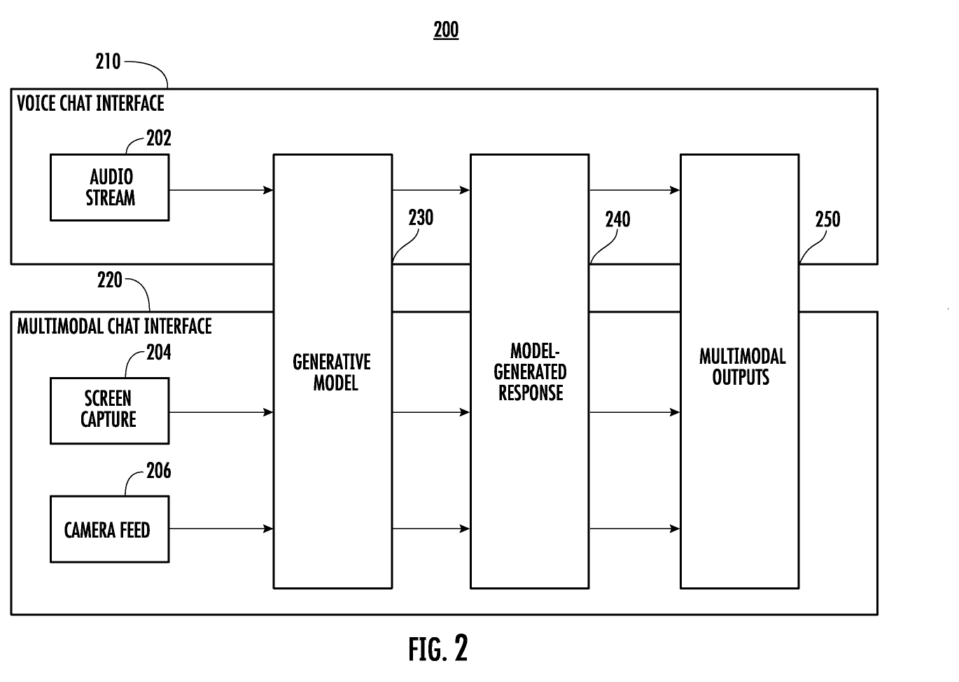

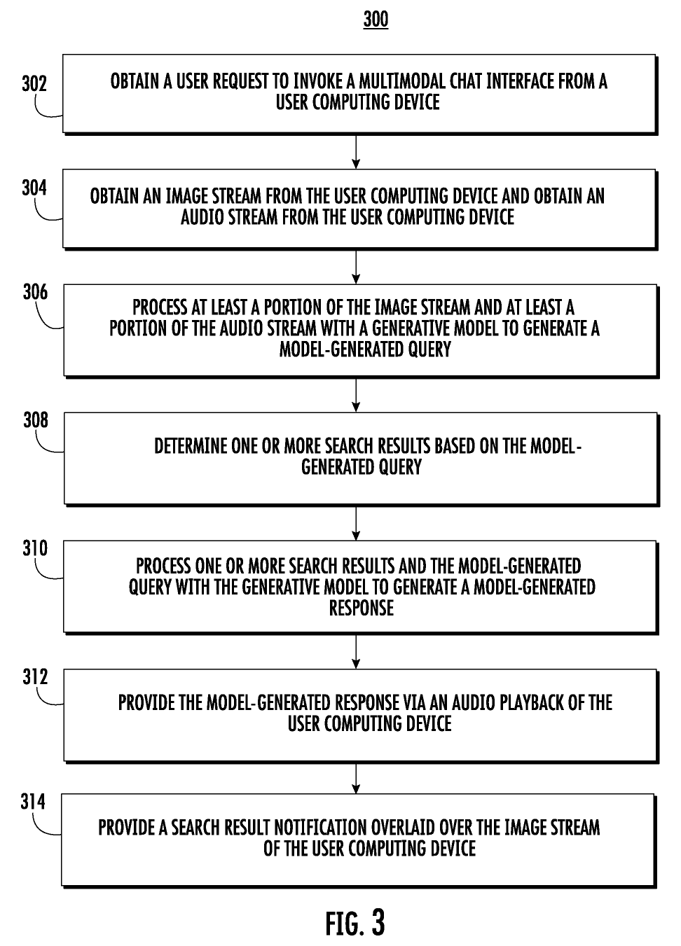

FIG. 2 depicts a block diagram of an example artificial intelligence chat system 200 according to example embodiments of the present disclosure. The artificial intelligence chat system 200 is similar to multimodal live chat interface system 100 of FIG. 1 except that artificial intelligence chat system 200 further includes a unimodal voice chat interface 210.

In particular, the artificial intelligence chat system 200 can include a plurality of input state options. The plurality of input state options can include a unimodal audio option, a screensharing multimodal state, and/or a camera feed multimodal state. The unimodal audio state can include a voice chat interface 210. The screensharing multimodal state and/or the camera feed multimodal state can be part of a multimodal chat interface 220.

The voice chat interface 210 can obtain an audio stream 202 descriptive of audio captured by one or more audio sensors of a user computing device. The audio can include voice commands, which may include queries and/or prompts. A generative model 230 (e.g., a large language model (e.g., a vision language model)) can process the audio stream 202 and/or a transcription of the audio stream 202 to generate a model-generated response 240. The model-generated response 240 can then be processed to generate one or more multimodal outputs 250, which can then be output via the voice chat interface 210. The one or more multimodal outputs 250 can include an audio output descriptive of a natural language response to the vocal inputs provided by the user. Additionally and/or alternatively, the one or more multimodal outputs 250 can include a visual notification provided via a screen of the user computing device and may be overlaid over the current interface display. The notification may include search results, a generated response, and/or other data.

The multimodal chat interface 220 can obtain an image stream and an audio stream 202 descriptive of audio captured by one or more audio sensors of a user computing device. The audio can include voice commands, which may include queries and/or prompts. In the screensharing multimodal state, the image stream may include a continuous screen capture 204 descriptive of a plurality of screen capture frames of content provided for display on a user computing device. In the camera feed multimodal state, the image stream may include a live camera feed 206 descriptive of a plurality of image frames generated with one or more image sensors associated with the user computing device.

A generative model 230 (e.g., a large language model (e.g., a vision language model)) can process the audio stream 202 and/or a transcription of the audio stream 202 and the image stream to generate a model-generated response 240. The model-generated response 240 can then be processed to generate one or more multimodal outputs 250, which can then be output via the multimodal chat interface 210. The one or more multimodal outputs 250 can include an audio output descriptive of a natural language response to the vocal inputs provided by the user, while including references to and/or contextually considering the visual inputs. Additionally and/or alternatively, the one or more multimodal outputs 250 can include a visual notification provided via a screen of the user computing device and may be overlaid over the current interface display. The notification may include search results, a generated response, and/or other data.

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain a user request to invoke a multimodal chat interface from a user computing device. The user request may be obtained in response to a user selecting a multimodal chat interface option within an application on a mobile computing device. The multimodal chat interface may include a viewfinder multimodal chat interface, a screensharing multimodal chat interface, and/or other multimodal chat interface. The user request may be generated in response to a user gesture, a voice command, and/or an interface selection.

At 304, the computing system can obtain an image stream from the user computing device and obtain an audio stream from the user computing device. The image stream can include a plurality of image frames. The audio stream can include audio data obtained via one or more audio sensors of the user computing device. The image stream may be descriptive of a live camera feed generated with one or more image sensors of a user computing device. In some implementations, the image stream may be descriptive of a live feed of content displayed on a screen of a user computing device, which was obtained via an overlay application. The audio stream may be in native audio format, may be compressed audio data, and/or may include transcribed audio data.

At 306, the computing system can process at least a portion of the image stream and at least a portion of the audio stream with a generative model to generate a model-generated query. Processing at least the portion of the image stream and at least the portion of the audio stream with the generative model to generate the model-generated query can include processing between three to five minutes of image frames. In some implementations, processing at least the portion of the image stream and at least the portion of the audio stream with the generative model to generate the model-generated query can include variably sampling frames of the image stream. A sampling rate of variably sampling can be based on performing pixel diffing associated with border pixels of the plurality of image frames. The model-generated query may include text data, image data, audio data, an embedding, a multimodal query, and/or other data. The generative model may include a vision language model. In some implementations, the vision language model may include an image encoder, an audio encoder, a text decoder, and/or an image decoder.

At 308, the computing system can determine one or more search results based on the model-generated query. The one or more search results may be determined by processing the model-generated query with an embedding model to generate a query embedding, determining result embeddings associated with the query embedding, and determining the one or more search results based on the results embeddings. The embedding-based search may be performed based on an embedding similarity measure and/or learned distribution identification. The one or more search results may include web resources and/or local search results on device. The one or more search results may include articles, blogs, social media posts, literary passages, audio files, images, and/or other content items.

At 310, the computing system can process one or more search results and the model-generated query with the generative model to generate a model-generated response. The model-generated response can be formatted to be directly responsive to the model-generated query. The model-generated response may include predicted text data, predicted audio data, predicted image data, predicted multimodal data, and/or other predicted data.

At 312, the computing system can provide the model-generated response via an audio playback of the user computing device. Providing the model-generated response may include processing the model-generated response with a text-to-speech model and transmitting the generated model-generated audio to speakers of the user computing device. During audio input and/or audio output, visual indicators may be provided for display indicating recording and/or audio output is being performed. The input and output indicators may differ.

At 314, the computing system can provide a search result notification overlaid over the image stream of the user computing device. The search result notification can include an indication of the one or more search results. The search result notification may include text, images, links, graphics, animations, and/or other visual features. The one or more search results can be provided in a visual notification. The visual notification may include a pop-up interface element and/or a swipe-up interface.

In some implementations, the computing system can provide a voice call interface before obtaining the user request to invoke the multimodal chat interface. The voice call interface can be configured to receive audio data via the one or more audio sensors of the user computing device and provide one or more predicted responses for output via at least one of a screen of the user computing device or one or more speakers of the user computing device.

In some implementations, the computing system can obtain, via the voice call interface, a voice command. The voice command can include a unimodal query. The computing system can process the voice command with the generative model to generate a model-generated predicted response to the unimodal query and provide the model-generated predicted response via the audio playback of the user computing device using the one or more speakers. The generative model can generate the model-generated predicted response based on one or more information data calls to one or more external tools.

In some implementations, the computing system can obtain a selection of an interface element of the search result notification and provide a web resource associated with the one or more search results for display. The multimodal chat interface can transition to a voice call interface. Transitioning can include stopping image stream collection and continuing audio stream collection.

Alternatively and/or additionally, the computing system can obtain a selection of an interface element of the search result notification and provide a web resource associated with the one or more search results for display. The multimodal chat interface can transition from camera capture to screen capture. Transitioning can include stopping image stream collection via one or more image sensors of the user computing device, beginning screen capture via an overlay interface of the multimodal chat interface, and continuing audio stream collection. In some implementations, the computing system can obtain a follow-up query. The follow-up query can be associated with display content on the user computing device. The computing system can obtain one or more screen capture frames, process the follow-up query and the one or more screen capture frames with the generative model to generate a model-generated follow-up response, and provide the model-generated follow-up response via the audio playback of the user computing device. The model-generated follow-up response can be responsive to the follow-up query.

The video feed context can be maintained continuously and/or may be maintained for a set period of time (e.g., a five minute context window). The video feed context can then be utilized for future query processing (e.g., future voice command inputs). In some implementations, the image frames can be processed to identify text, identify objects, and/or identify other features that can then be utilized to generate a representation, which may be stored in place of the image frames to provide a lightweight context representation for future processing.

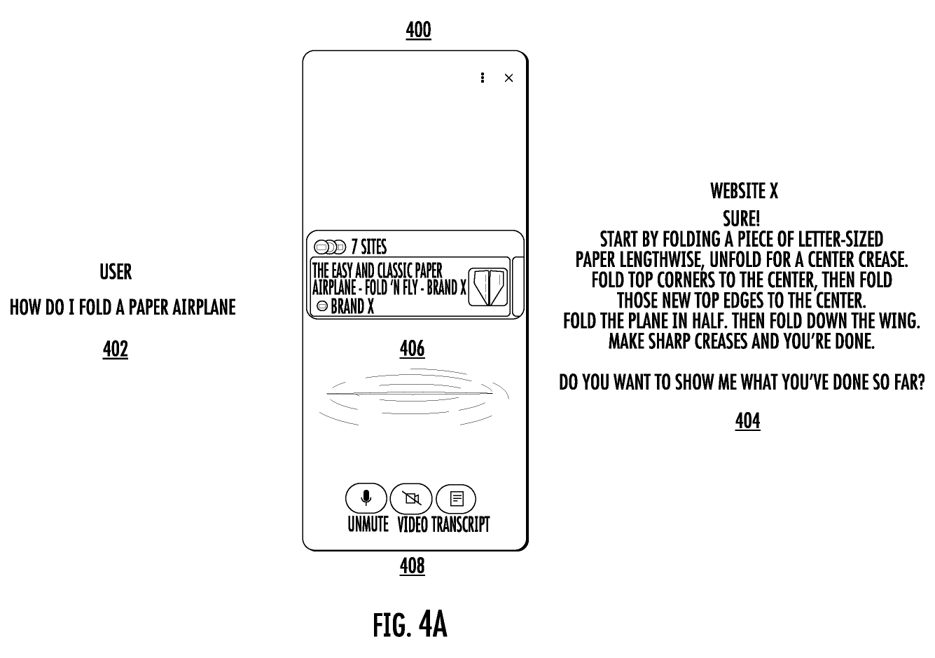

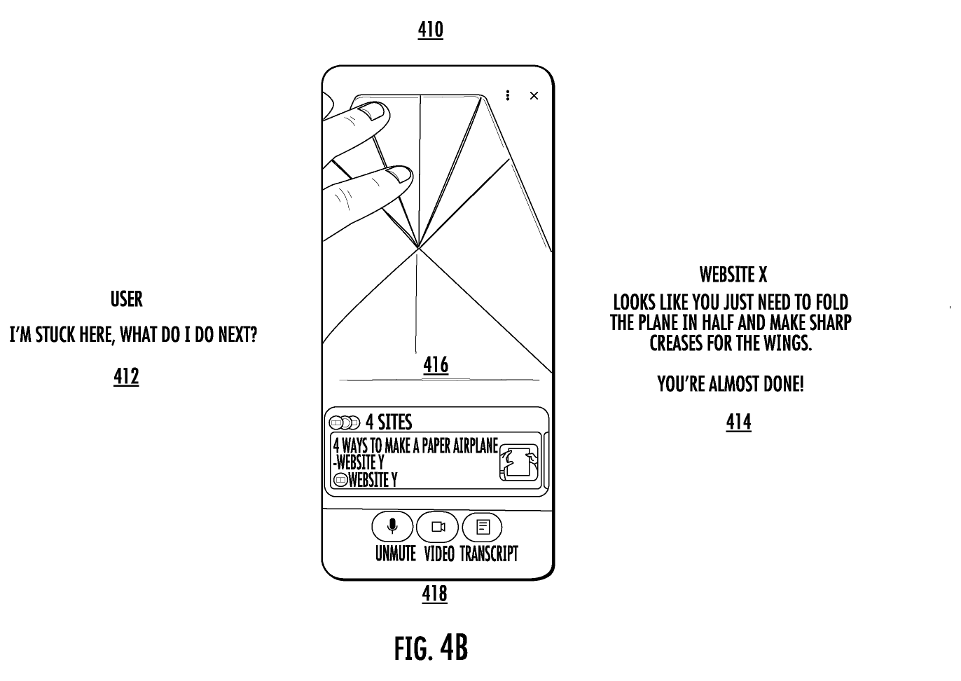

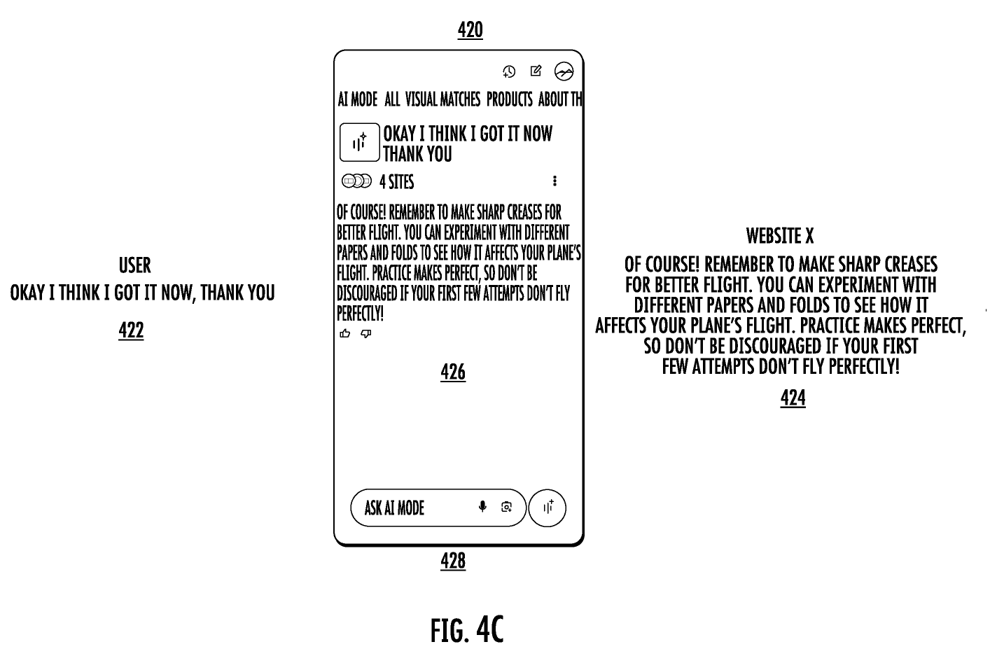

FIGS. 4A – 4C depict illustrations of an example dynamic interface according to example embodiments of the present disclosure. In particular, FIGS. 4A – 4C depict three different states of the dynamic interface. FIG. 4A depicts a voice call state 400. FIG. 4B depicts a multimodal call state 410. FIG. 4C depicts a transcript state 420.

The voice call state 400 can obtain a voice input 402, which can be processed to identify search results and generate a model-generated response 404. The model-generated response 404 can be provided for output via an audio playback. The search results may be provided for display via a visual notification 406. The user can then navigate through the different states via interacting with one or more user interface elements 408.

The multimodal call state 410 can obtain a voice input 412 and an image input, which can be processed to identify search results and generate a model-generated response 414. The model-generated response 414 can be provided for output via an audio playback. The search results may be provided for display via a visual notification 406, which may be provided overlaid over the currently displayed content. The user can then navigate through the different states via interacting with one or more user interface elements 418.

The transcript state 420 can continue to provide an interface to obtain voice inputs 422 and generate audio response outputs 424, while providing a chat transcript 426 for display. The chat transcript 426 can include transcripts of the inputs, outputs, search results, and/or chat contexts. Additionally, one or more user interface elements 428 may be provided to allow a user to ask follow-up questions, provide further inputs, and/or search the transcript.

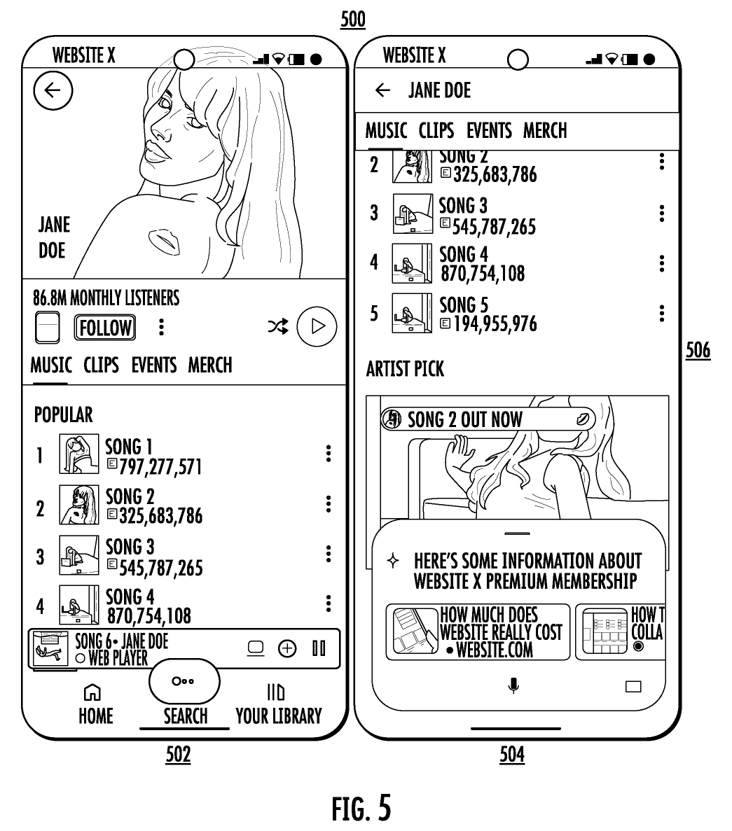

FIG. 5 depicts an illustration of an example screensharing chat notification interface 500 according to example embodiments of the present disclosure. The screensharing chat notification interface 500 can obtain an image stream descriptive of the display content 502, while also obtaining an audio stream that includes a question about the display content 502. The display content 502 and the question can be processed to generate a model-generated response. The model-generated response can then be provided via audio playback and/or visual notifications. For example, a response may be provided over a speaker, while providing a visual notification 504 overlaid over the currently displayed content 506. The visual notification 504 may include search results and a natural language text string.

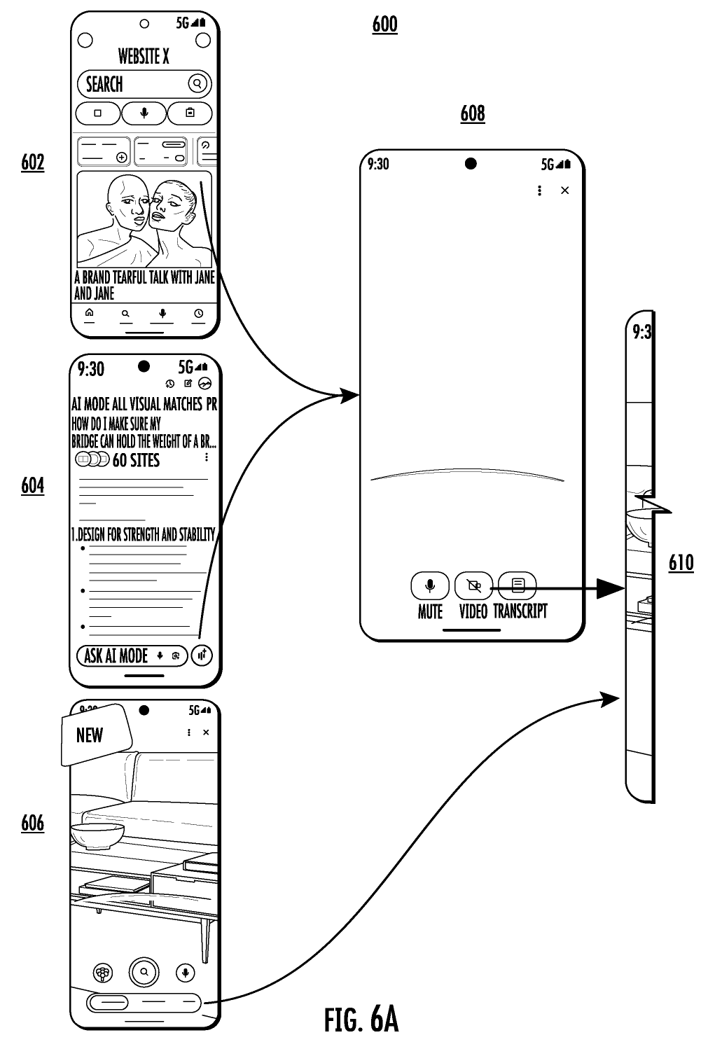

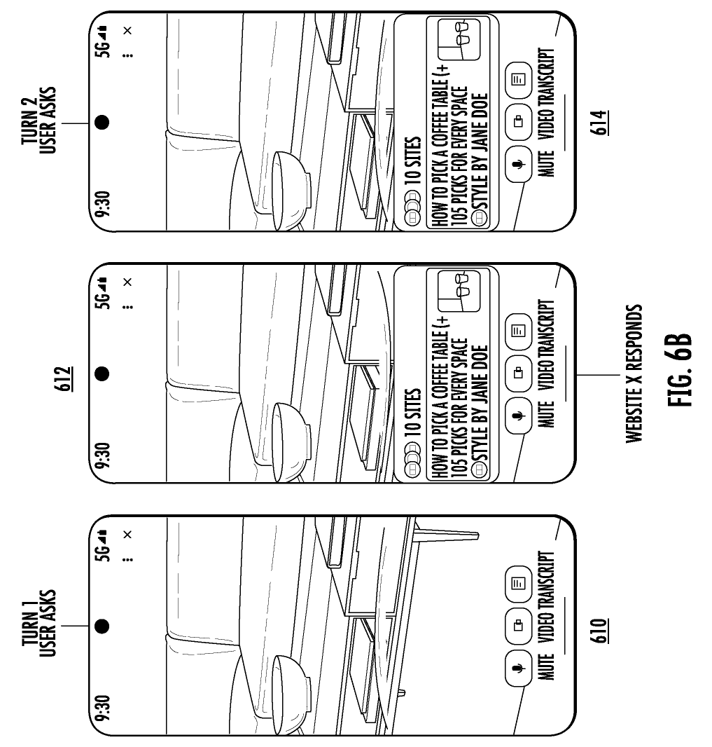

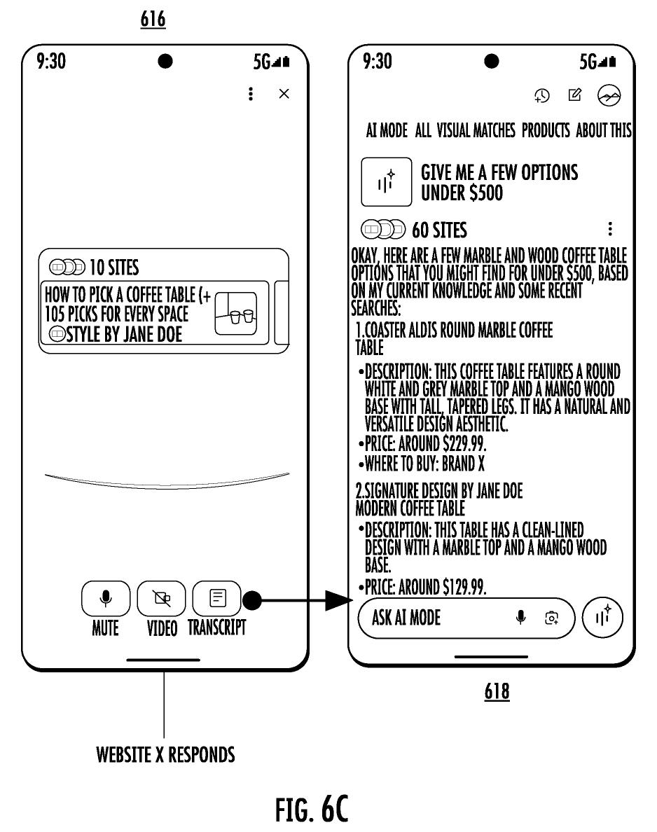

FIGS. 6A – 6C depicts illustrations of an example interface flow 600 according to example embodiments of the present disclosure. FIG. 6A depicts different entry points for the multimodal chat interface. In particular, a voice chat interface 608 can be invoked from an application home page 602 and/or via selection of a call option within a search results interface 604. A video call option can then be selected within the voice chat interface 608 to invoke a multimodal chat interface. Alternatively and/or additionally, the multimodal chat interface may be invoked in response to a video call option being selected within a visual search application 606.

In FIG. 6B, at 610, a voice input and an image input can be obtained and processed to identify search results and generate a model-generated response. At 612, an audio output and a visual notification can be provided as output. At 614, follow-up inputs can be obtained while the visual notification is still provided for display.

In FIG. 6C, at 616, a follow-up response and notification can be generated and provided for display. At 618, the interface may transition to a transcript interface in response to a user selection. The transcript interface can include a transcript of the chat session and may include relevant image frames, audio snippets, audio transcriptions, search results, model-generated responses, context information, and/or other data.

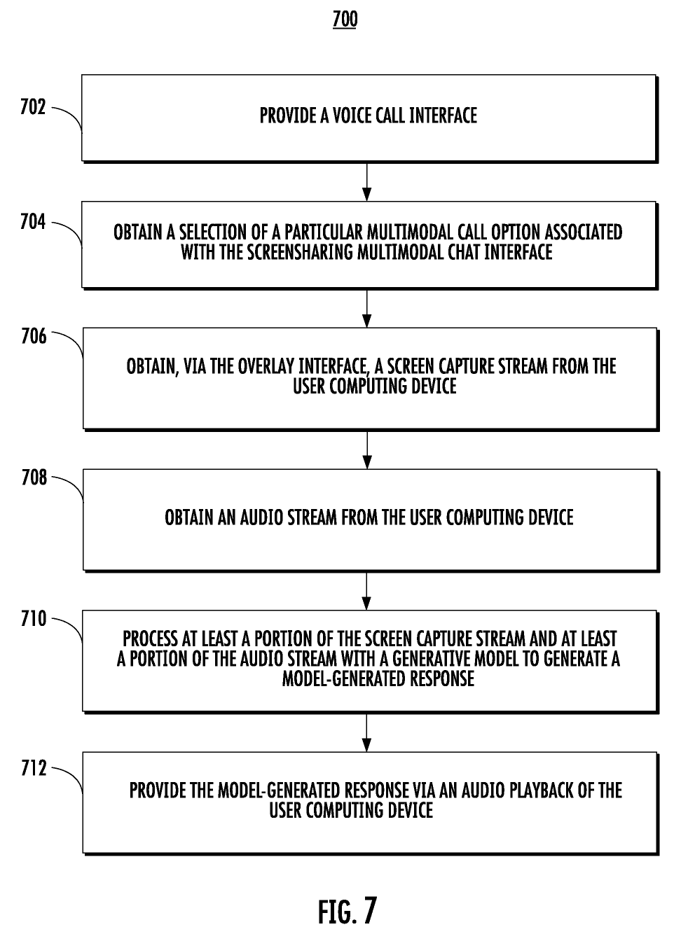

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can provide a voice call interface. The voice call interface can be configured to receive audio data via the one or more audio sensors of a user computing device and provide one or more predicted responses for output via one or more output components of the user computing device. The voice call interface can provide multimodal call options via selectable user interface elements. The multimodal call options can include a viewfinder multimodal chat interface and a screensharing multimodal chat interface. The voice call interface may be unimodal in nature and may process audio data without visual data. In some implementations, the voice call interface may obtain, determine, generate, and/or process context data in order to generate predicted responses. The multimodal call options may obtain image data, audio data, text data, context data, latent encoding data, and/or other data that can then be processed to generate the predicted responses.

In some implementations, the viewfinder multimodal chat interface can be configured to receive viewfinder image data via one or more image sensors of the user computing device and audio data via the one or more audio sensors of the user computing device and providing one or more predicted responses for output via the one or more output components of the user computing device. The viewfinder multimodal chat interface may obtain and process a live camera feed from one or more image sensors of a user computing device.

In some implementations, the screensharing multimodal chat interface can be configured to receive screen capture image data via a screen capture overlay interface of the user computing device and audio data via the one or more audio sensors of the user computing device and providing one or more predicted responses for output via the one or more output components of the user computing device. The screensharing multimodal chat interface may obtain and process a live screen recording feed of a user computing device.

At 704, the computing system can obtain a selection of a particular multimodal call option associated with the screensharing multimodal chat interface. The selection may be received via a touch screen, a voice command, a gesture, and/or other input.

At 706, the computing system can obtain, via the overlay interface, a screen capture stream from the user computing device. The screen capture stream can include a plurality of image frames descriptive of display content provided for display on the user computing device. The screen capture stream may include sampling screenshots at an interval. The interval may be a variable rate determined based on computational resources at that time, computational resources for the device, pixel diffing, the dynamics of the screen, previous interaction history, the type of content depicted, a rate of vocal audio retrieved, and/or other factors.

At 708, the computing system can obtain an audio stream from the user computing device. The audio stream can include audio data obtained via the one or more audio sensors of the user computing device. The audio stream may be filtered with a preprocessing block to remove ambient noise, environmental sounds, and/or other non-vocal data.

At 710, the computing system can process at least a portion of the screen capture stream and at least a portion of the audio stream with a generative model to generate a model-generated response. The generative model may include a generative language model (e.g., a large language model, an autoregressive language model, a vision language model, and/or other models). The model-generated response may include a predicted response to a voice command identified within the audio stream.

In some implementations, processing at least the portion of the screen capture stream and at least the portion of the audio stream with the generative model to generate the model-generated response can include processing at least the portion of the screen capture stream and at least the portion of the audio stream with the generative model to generate a model-generated query, determining one or more search results based on the model-generated query, and processing one or more search results and the model-generated query with the generative model to generate the model-generated response.

Alternatively and/or additionally, processing at least the portion of the screen capture stream and at least the portion of the audio stream with the generative model to generate the model-generated response can include processing one or more frames of the plurality of frames to generate a context dataset including details associated with features depicted in the one or more frames, processing at least the portion of the audio stream to generate text data descriptive of the audio data, and processing the context dataset and the text data with the generative model to generate the model-generated response. Generating the contextual dataset can include determining a plurality of object labels descriptive of a plurality of objects identified within the one or more frames. In some implementations, generating the contextual dataset can include performing optical character recognition on the one or more frames.

At 712, the computing system can provide the model-generated response via an audio playback of the user computing device. The audio playback may be provided with a visual indicator on a screen of a computing device.

In some implementations, the computing system can generate a multimodal transcript of a session including an audio transcript, search results, and relevant image frames. The audio transcript can include input voice commands and output model-generated responses. The search results may have been determined in response to receiving the input voice commands, storing the multimodal transcript, and providing the multimodal transcript for display.

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a user request to invoke a screensharing multimodal chat interface from a user computing device. The user request may include a selection of a user interface element. Alternatively and/or additionally, the user request may be based on a received voice command.

At 804, the computing system can obtain, via an overlay interface, a screen capture stream from the user computing device and obtain an audio stream from the user computing device. The screen capture stream can include a plurality of image frames descriptive of display content provided for display on the user computing device. The audio stream can include audio data obtained via one or more audio sensors of the user computing device. The screen capture stream may include a steady stream of frames and/or may include a variable rate of frames. In some implementations, the resolution of the frames may vary based on frame generation rate, a type of request, and/or other contexts. The audio stream may include a transcription of the audio data.

At 806, the computing system can process at least a portion of the screen capture stream and at least a portion of the audio stream with a generative model to generate a model-generated query. The model-generated query may include a token representation. The token representation can be a computer-readable token descriptive of a determined semantic request associated with the audio stream and screen capture stream.

At 808, the computing system can determine one or more search results based on the model-generated query. The search may be an embedding search, a generative model retrieval-augmented generation processing search, a keyword search, and/or other search.

At 810, the computing system can process one or more search results and the model-generated query with the generative model to generate a model-generated response. The one or more search results may be processed to identify relevant passages, which are then fed to the generative model with the model-generated query in order to generate the model-generated response. The model-generated query may include a token that can be fed to the generative model with an encoding bypass to reduce computing redundancies and leverage the previous model inference.

In some implementations, the computing system can process a frame of the plurality of frames of the screen capture stream to determine the display content is part of a particular web resource and obtain a full content item associated with the particular web resource. The full content item can include the display content. At least one of the model-generated query or the model-generated response can be determined based on the full content item. In some implementations, obtaining the full content item can include identifying a uniform resource locator associated with the particular web resource and at least one of obtaining source code data for the particular web resource or obtaining a document associated with the particular web resource.

At 812, the computing system can provide the model-generated response via an audio playback of the user computing device. The audio playback may include a text-to-speech conversion and a speaker transfer to match a selected speaker tone and pitch.

At 814, the computing system can provide, during audio playback, an audio output indicator overlaid over a portion of the display content. The overlay interface can continue to obtain data descriptive of the screen capture stream during the display of the audio output indicator. The overlay interface can capture the plurality of image frames above a display content interface layer and below an indicator interface layer that displays the audio output indicator to provide for full display content capture even when the audio output indicator is provided for display.

In some implementations, the systems and methods disclosed herein can leverage a visual search interface in an operating system of a computing device. The visual search interface can generate display data descriptive of content provided for display on the computing device and can process the display content to determine information associated with the displayed content. The visual search interface can include a display capture component for generating the display data, one or more on-device machine-learned models for processing the display data, and/or a transmission component for interfacing with one or more other computing systems.

Visual search in the operating system can include an interface at the operating system level that users can leverage to process visual data across applications executed by a computing device. The visual search interface can be invoked via a user input, which can include a voice command, a touch gesture (e.g., a long press, a swipe (e.g., a diagonal swipe), a lasso, a squiggle, etc.), and/or one or more other user inputs. The visual search in the operating system can be included in mobile computing devices (e.g., a smartphone, a tablet, and/or a smart wearable), a smart television, a smart appliance, and/or a desktop computing device. In some implementations, a visual search interface may be implemented as an extension and/or an overlay interface for a web browser.

Obtaining additional information associated with information provided for display across different applications and/or media files can be difficult when the data is visual, niche, and/or not selectable in a current native form. Therefore, a user may struggle in attempting to construct a search query to search for additional information. In some instances, a user may capture a screenshot and utilize the screenshot as a query image. However, the search may lead to irrelevant search results associated with items not of interest to the user. Additionally, screenshot capture and/or screenshot cropping can rely on several user inputs being provided that may still fail to provide desired results.

An overlay visual search application at the operating system level can be leveraged to perform visual search across different applications, which may include social media applications, browser applications, media content viewing applications, map applications, and/or a viewfinder application. The visual search can be implemented via a kernel of an operating system installed on a computing device. The operating system can obtain and/or process data being received from one or more applications to then be transmitted to one or more server computing systems to perform one or more artificial intelligence techniques for object classification, object recognition, optical character recognition, image captioning, image-to-text summarization, text summarization, query suggestion, and/or web search based on image and/or text processing. The overlay interface can generate display data, detect objects, and provide detection indicators in a singular interface and can then transmit data for further processing based on a user selection.

Visual search in an operating system can be included in computing devices to provide a readily available interface for users to access a plurality of artificial intelligence processing systems for object classification, image captioning, image-to-text summarization, response generation, web search, and/or one or more other artificial intelligence techniques. Smart phone and smart wearable manufacturers in general may implement visual search in the operating system to leverage the utility of machine-learned models and/or search engines across different applications. The visual search in the operating system can then be utilized to determine secondary applications associated with the visual search data to provide suggestions to transmit (or share) visual search data across applications on the device.

The systems and methods disclosed herein can leverage a visual search application in the operating system to provide an overlay visual search interface that can interface with a plurality of different applications on the computing device without the computational cost and/or privacy concerns of traditional visual search techniques. For example, the visual search interface can generate display data based on content currently and/or previously provided for display and can process the display data to perform object detection, optical character recognition, segmentation, and/or other techniques on the computing device without the upload and/or download costs of interfacing with server computing systems. Additionally and/or alternatively, the display data may be generated and temporarily stored during the visual search process, then deleted to save on storage space and free up resources for future visual search instances. The data generation and processing on-device can reduce the data transmitted to server computing systems and can increase privacy.

The visual search interface may include and/or utilize a plurality of on-device machine-learned models. The on-device machine-learned models can include an object detection model, an optical character recognition model, a segmentation model, a language model, a vision language model, an embedding model, an input determination model (e.g., a gesture recognition model), a speech-to-text model, an augmentation model, a suggestion model, and/or other machine-learned models. The on-device machine-learned models can be utilized for on-device processing. Additionally and/or alternatively, a portion and/or all of the display data may be transmitted to a server computing system to perform additional processing tasks, which can include search result determination with a search engine, content generation with a generative model, and/or other processing tasks.

The visual search data generated and/or determined based on on-device and/or on-server processing may provide additional information to a user that may have been previously unobtainable by the user (and/or traditionally more tedious and computationally expensive to obtain). The visual search data may be further processed to generate application suggestions to interact with and/or leverage the additional information. The application suggestions can be based on data types associated with the determined visual search results and/or based on topics, tasks, and/or entities associated with the visual search results. The application suggestions may be selectable to navigate to and/or transmit visual search data to one or more applications on the computing device. The transmission can be performed at the operating system level and may be facilitated via one or more application programming interfaces. A model-generated content item may be generated based on the visual search data and/or based on a selected application.

A user may struggle in applying the additional knowledge to other tasks, such as informing others and/or acting on the additional information (e.g., generating lists, messaging others, writing a social media post, and/or interacting with the display data). An overlay visual search application at the operating system level can be leveraged to perform visual search across different applications, and the visual search data can be transmitted to other applications on the device. The operating system can obtain and/or process data being received from one or more applications to then be processed to perform one or more artificial intelligence techniques to generate outputs that may then be processed to suggest second applications to transmit the visual search data for actionable use of the visual search data.

Additionally and/or alternatively, the visual search interface in the operating system can be configured to obtain prompt inputs from the user to aggregate data from a plurality of different applications on the computing device and/or the web. The prompt can be processed to determine one or more applications on the computing device are associated with a topic, task, and/or content type associated with the request of the prompt. An application call can then be generated and performed based on the application determination. The application call can access the one or more particular applications, search for relevant content items, and obtain content items associated with the prompt. The obtained content items may be provided for display. Alternatively and/or additionally, the content items can be processed with a generative model to generate a structured output that includes the information from the content items that are responsive to the prompt, and the information can be formatted in a digestible format, which can include a graphic, a story, an article, an image, a poem, a web page, a widget, a game, and/or other data formats.

The visual search interface may include an audio search interface, a multimodal search interface, and/or other data processing interfaces implemented at the operating system level to process data associated with a plurality of different data types. Therefore, a user may invoke an overlay interface to process image data, video data, audio data, text data, statistical data, latent encoding data, and/or multimodal data across a plurality of different applications.

In some implementations, storing the selected content dataset with the content grouping can include storing the selected content dataset with user search history data (e.g., the content snippets may be saved in a user’s search history and/or browsing history). The computing system can tune a machine-learned personalization model based on the content grouping and the user search history data. The machine-learned personalization model can be associated with a particular user. In some implementations, the computing system can determine, with the machine-learned personalization model, a suggested content item based on the content grouping and provide the suggested content item for display.

In particular, the systems and methods disclosed herein can leverage user-input based content segmentation, context data determination, and/or a generative model to generate content-rich content snippets that can be categorized, grouped, and/or utilized for personalizing suggestions for a user. For example, a user may be viewing content, which may include browsing a web page via a browser application, viewing images in an image gallery, viewing social media posts via a social media application, viewing streaming content via a streaming application, and/or viewing other applications. The user may see an object of interest that they want to learn more information about, store the sub-portion of the content for later viewing, and/or share with other users. The user may invoke an overlay application. The overlay interface can be interacted with to segment the sub-portion of content provided for display based on a user input (e.g., an object selection tap, a lasso gesture, a scribble-over gesture, and/or other input). The segmented sub-portion can then be saved with source data (e.g., a URL, an application source application programming interface, and/or other source information) and/or other context data to generate a content snippet for the selected content. The content snippet may be stored in a user-specific collection, may be shareable to other users (e.g., via a text, email, Bluetooth transmission, and/or other transmission), may be processed by a search engine and/or machine-learned models to determine additional information about the content of interest, and/or utilized to determine suggested content for the user.

The content snippet may include visual search result data generated by a visual search interface of the overlay interface by processing the segmented sub-portion of the content with a search engine and/or one or more machine-learned models. The visual search result data can include an object classification, visual search results associated with the segmented content (e.g., an image search result, web resource, product search result, and/or other search result), a content grouping (e.g., a grouping association with one or more related content snippets/content item), and/or a model-generated response to a prompt that includes the segmented content and/or user input data (e.g., an input question). The content snippet may be processed with a generative model (e.g., a large language model (e.g., a vision language model)) to determine one or more labels for the content snippet. Additionally and/or alternatively, the content snippet and one or more other content snippets may be processed with the generative model to generate content groupings that include grouping content snippets based on determined semantic relationships and/or other shared topics. In some implementations, the generative model may be utilized to process user context data to determine when to suggest one or more content snippets to a user.

Content snippet generation, sharing, and/or saving can be implemented via an overlay interface, which may include an overlay interface for visual search at the operating system level. For example, a user computing device (e.g., a mobile computing device) may include an overlay interface that may be part of a device operating system and/or may be a third party application that may interface with the device operating system to provide the overlay interface across a plurality of different applications provided by the user computing device. The content snippet generation, sharing, and/or storing interface can be implemented and/or provided as part of the overlay application to provide accessibility across the plurality of different applications and/or types of content. The overlay interface may include a visual search functionality, a content snippet generation functionality, and/or one or more other functionalities for aiding a user with interacting with and/or understanding the content being provided for display.

Saving and/or sharing content provided for display can be difficult. In particular, screenshots and/or links can provide limited information and/or may lack specificity associated with a user intent. Additionally, taking a screenshot or saving a link may include a plurality of inputs for data that may be lost in the plurality of other datasets within an image gallery of the device and/or in a notes app. Taking the screenshot and/or saving the link may also redirect the user out of the current application they are utilizing. Moreover, the features of interest the user wants to capture may be limited to only a small portion of the displayed content, which may rely on screenshot cropping for more tailored capture. Furthermore, utilization of the screenshot and/or link may be limited.

An overlay application and/or an interface implemented at an operating system level of a computing device can be utilized to allow users to generate content snippets that isolate regions of content of interest and store the isolated content portions with source data and/or other context data without navigating away from the application and/or content currently provided for display. The content snippets can provide more immersive and/or more contextually-aware data packets for searching, storing, and/or sharing. The content snippets may be processed to generate content groupings that can then be utilized for categorizing content snippets, for determining content suggestions, and/or for providing content snippets as search results. A large language model (LLM) and/or other generative model may be utilized for determining the content groupings and/or for determining when to provide a particular content snippet to a user.

The content snippets and/or content groupings can be utilized for isolating data of interest to a user, which can then be utilized for determining user interests and/or providing search suggestions and/or content suggestions. For example, a personalization model may be tuned and/or trained on the content snippets, content labels, and/or content groupings. In some implementations, content groupings may be utilized to determine user interests, which may be leveraged by a generative model for generating suggested queries, which may then be proactively searched to obtain, determine, and/or provide resource suggestions (e.g., content item suggestions) to a user based on the determined interests. In some implementations, the proactively determined and/or obtained content items may be added to the content grouping. The content snippets may be utilized with visual search techniques to generate content rich user-specific collections. In some implementations, the content snippets may be provided in a snippet-specific interface for viewing, managing, and/or interacting with the content snippets. Additionally and/or alternatively, the content snippets may be provided for display as search results, provided as suggested content in a discover feed, and/or one or more other interfaces.

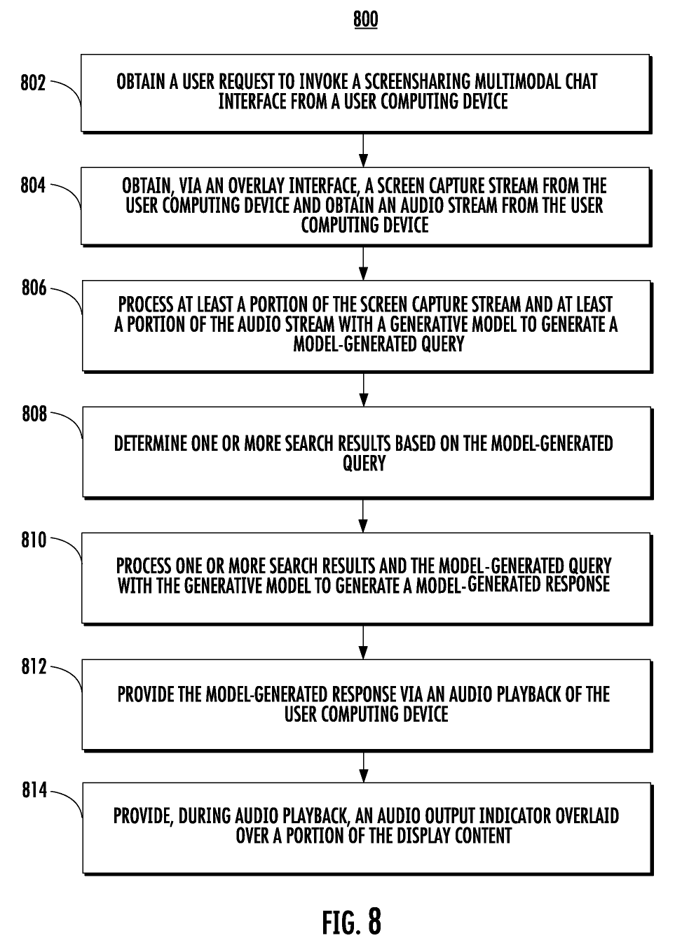

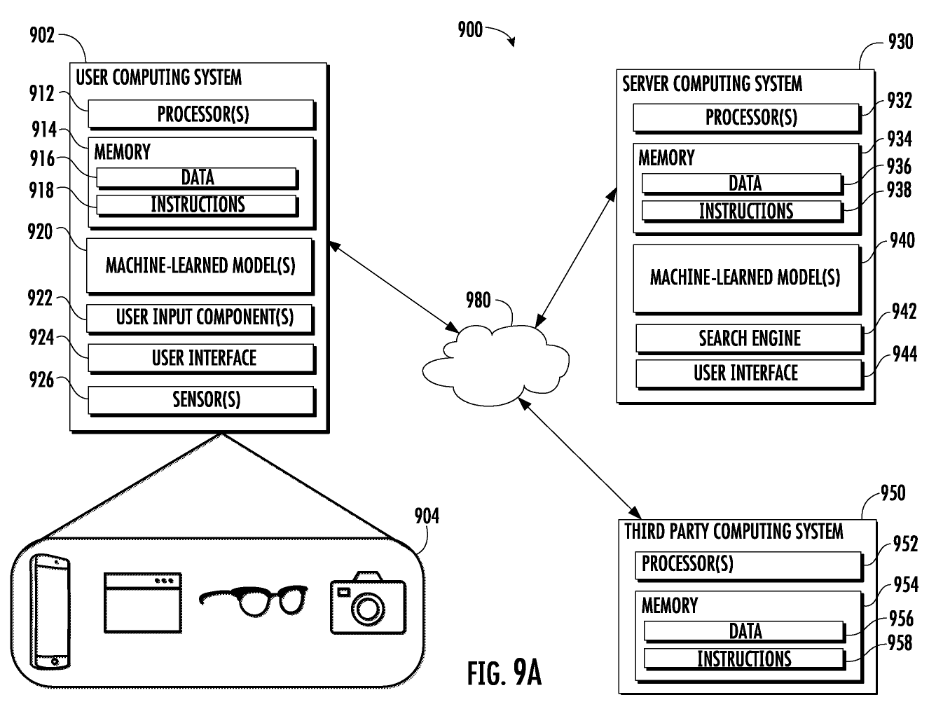

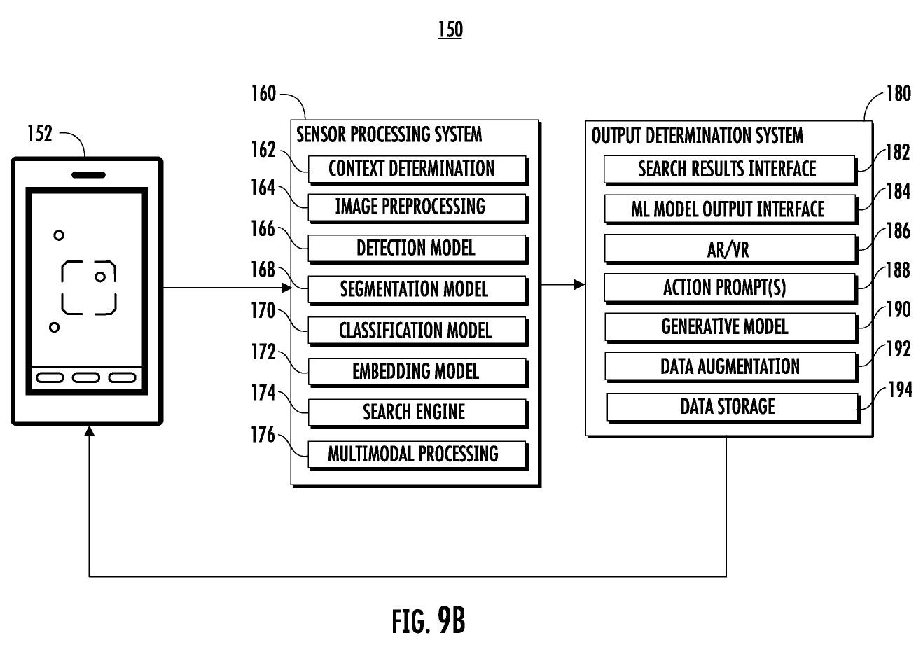

FIG. 9A depicts a block diagram of an example computing system 900 that performs live multimodal processing according to example embodiments of the present disclosure. The system 900 includes a user computing system 902, a server computing system 930, and/or a third party computing system 950 that are communicatively coupled over a network 980.

The user computing system 902 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 902 includes one or more processors 912 and a memory 914. The one or more processors 912 can be any suitable processing device (e.g., a processor core, a microprocessor, an ASIC, a FPGA, a controller, a microcontroller, etc.) and can be one processor or a plurality of processors that are operatively connected. The memory 914 can include one or more non-transitory computer-readable storage mediums, such as RAM, ROM, EEPROM, EPROM, flash memory devices, magnetic disks, etc., and combinations thereof. The memory 914 can store data 916 and instructions 918 which are executed by the processor 912 to cause the user computing system 902 to perform operations.

In some implementations, the user computing system 902 can store or include one or more machine-learned models 920. For example, the machine-learned models 920 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 920 can be received from the server computing system 930 over network 980, stored in the user computing device memory 914, and then used or otherwise implemented by the one or more processors 912. In some implementations, the user computing system 902 can implement multiple parallel instances of a single machine-learned model 920 (e.g., to perform parallel machine-learned model processing across multiple instances of input data and/or detected features).

More particularly, the one or more machine-learned models 920 may include one or more detection models, one or more classification models, one or more segmentation models, one or more augmentation models, one or more generative models, one or more natural language processing models, one or more optical character recognition models, and/or one or more other machine-learned models. The one or more machine-learned models 920 can include one or more transformer models. The one or more machine-learned models 920 may include one or more neural radiance field models, one or more diffusion models, and/or one or more autoregressive language models.

The one or more machine-learned models 920 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 920 can process image data, text data, audio data, and/or latent encoding data to generate output data that can include image data, text data, audio data, and/or latent encoding data. The one or more machine-learned models 920 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, arXiv:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 940 can be included in or otherwise stored and implemented by the server computing system 930 that communicates with the user computing system 902 according to a client-server relationship. For example, the machine-learned models 940 can be implemented by the server computing system 930 as a portion of a web service (e.g., a viewfinder service, a visual search service, an image processing service, an ambient computing service, and/or an overlay application service). Thus, one or more models 920 can be stored and implemented at the user computing system 902 and/or one or more models 940 can be stored and implemented at the server computing system 930.

The user computing system 902 can also include one or more user input components 922 that receives user input. For example, the user input component 922 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 902 can store and/or provide one or more user interfaces 924, which may be associated with one or more applications. The one or more user interfaces 924 can be configured to receive inputs and/or provide data for display (e.g., image data, text data, audio data, one or more user interface elements, an augmented-reality experience, a virtual reality experience, and/or other data for display. The user interfaces 924 may be associated with one or more other computing systems (e.g., server computing system 930 and/or third party computing system 950). The user interfaces 924 can include a viewfinder interface, a search interface, a generative model interface, a social media interface, and/or a media content gallery interface.

The user computing system 902 may include and/or receive data from one or more sensors 926. The one or more sensors 926 may be housed in a housing component that houses the one or more processors 912, the memory 914, and/or one or more hardware components, which may store, and/or cause to perform, one or more software packets. The one or more sensors 926 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user’s environment (e.g., an image of a user’s environment, a recording of the environment, and/or the location of the user).

The user computing system 902 may include, and/or be part of, a user computing device 904. The user computing device 904 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 904. For example, a camera of a smartphone may be utilized to capture image data descriptive of the environment, and/or an overlay application of the user computing device 904 can be utilized to track and/or process the data being provided to the user. Similarly, one or more sensors associated with a smart wearable may be utilized to obtain data about a user and/or about a user’s environment (e.g., image data can be obtained with a camera housed in a user’s smart glasses). Additionally and/or alternatively, the data may be obtained and uploaded from other user devices that may be specialized for data obtainment or generation.

The server computing system 930 includes one or more processors 932 and a memory 934. The one or more processors 932 can be any suitable processing device (e.g., a processor core, a microprocessor, an ASIC, a FPGA, a controller, a microcontroller, etc.) and can be one processor or a plurality of processors that are operatively connected. The memory 934 can include one or more non-transitory computer-readable storage mediums, such as RAM, ROM, EEPROM, EPROM, flash memory devices, magnetic disks, etc., and combinations thereof. The memory 934 can store data 936 and instructions 938 which are executed by the processor 932 to cause the server computing system 930 to perform operations.

In some implementations, the server computing system 930 includes or is otherwise implemented by one or more server computing devices. In instances in which the server computing system 930 includes plural server computing devices, such server computing devices can operate according to sequential computing architectures, parallel computing architectures, or some combination thereof.

As described above, the server computing system 930 can store or otherwise include one or more machine-learned models 940. For example, the models 940 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 940 are discussed with reference to FIG. 9B.

Additionally and/or alternatively, the server computing system 930 can include and/or be communicatively connected with a search engine 942 that may be utilized to crawl one or more databases (and/or resources). The search engine 942 can process data from the user computing system 902, the server computing system 930, and/or the third party computing system 950 to determine one or more search results associated with the input data. The search engine 942 may perform term based search, label based search, Boolean based searches, image search, embedding based search (e.g., nearest neighbor search), multimodal search, and/or one or more other search techniques.

The server computing system 930 may store and/or provide one or more user interfaces 944 for obtaining input data and/or providing output data to one or more users. The one or more user interfaces 944 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 902 and/or the server computing system 930 can train the models 920 and/or 940 via interaction with the third party computing system 950 that is communicatively coupled over the network 980. The third party computing system 950 can be separate from the server computing system 930 or can be a portion of the server computing system 930. Alternatively and/or additionally, the third party computing system 950 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model’s performance on that runtime instance (e.g., online training/learning). Example data types for the training instance and various tasks associated therewith are described throughout the present disclosure.

The third party computing system 950 can include one or more processors 952 and a memory 954. The one or more processors 952 can be any suitable processing device (e.g., a processor core, a microprocessor, an ASIC, a FPGA, a controller, a microcontroller, etc.) and can be one processor or a plurality of processors that are operatively connected. The memory 954 can include one or more non-transitory computer-readable storage mediums, such as RAM, ROM, EEPROM, EPROM, flash memory devices, magnetic disks, etc., and combinations thereof. The memory 954 can store data 956 and instructions 958 which are executed by the processor 952 to cause the third party computing system 950 to perform operations. In some implementations, the third party computing system 950 includes or is otherwise implemented by one or more server computing devices.

The network 980 can be any type of communications network, such as a local area network (e.g., intranet), wide area network (e.g., Internet), or some combination thereof and can include any number of wired or wireless links. In general, communication over the network 980 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 920 and/or 940) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 902 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 900.

The central intelligence layer can communicate with a central device data layer. The central device data layer can be a centralized repository of data for the computing system 900. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 9B depicts a block diagram of an example computing system 150 that performs live multimodal processing according to example embodiments of the present disclosure. In particular, the example computing system 150 can include one or more computing devices 152 that can be utilized to obtain, and/or generate, one or more datasets that can be processed by a sensor processing system 160 and/or an output determination system 180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 152 (e.g., one or more sensors in the computing device 152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 160. The sensor processing system 160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 162, which may determine a context associated with one or more content items. The context determination block 162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 160 may include an image preprocessing block 164. The image preprocessing block 164 may be utilized to adjust one or more values of an obtained and/or received image to prepare the image to be processed by one or more machine-learned models and/or one or more search engines 174. The image preprocessing block 164 may resize the image, adjust saturation values, adjust resolution, strip and/or add metadata, and/or perform one or more other operations.

In some implementations, the sensor processing system 160 can include one or more machine-learned models, which may include a detection model 166, a segmentation model 168, a classification model 170, an embedding model 172, and/or one or more other machine-learned models. For example, the sensor processing system 160 may include one or more detection models 166 that can be utilized to detect particular features in the processed dataset. In particular, one or more images can be processed with the one or more detection models 166 to generate one or more bounding boxes associated with detected features in the one or more images.

Additionally and/or alternatively, one or more segmentation models 168 can be utilized to segment one or more portions of the dataset from the one or more datasets. For example, the one or more segmentation models 168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 170 can be utilized to process image data, text data, audio data, latent encoding data, multimodal data, and/or other data to generate one or more classifications. The one or more classification models 170 can include one or more image classification models, one or more object classification models, one or more text classification models, one or more audio classification models, and/or one or more other classification models. The one or more classification models 170 can process data to determine one or more classifications.

In some implementations, data may be processed with one or more embedding models 172 to generate one or more embeddings. For example, one or more images can be processed with the one or more embedding models 172 to generate one or more image embeddings in an embedding space. The one or more image embeddings may be associated with one or more image features of the one or more images. In some implementations, the one or more embedding models 172 may be configured to process multimodal data to generate multimodal embeddings. The one or more embeddings can be utilized for classification, search, and/or learning embedding space distributions.

The sensor processing system 160 may include one or more search engines 174 that can be utilized to perform one or more searches. The one or more search engines 174 may crawl one or more databases (e.g., one or more local databases, one or more global databases, one or more private databases, one or more public databases, one or more specialized databases, and/or one or more general databases) to determine one or more search results. The one or more search engines 174 may perform feature matching, text based search, embedding based search (e.g., k-nearest neighbor search), metadata based search, multimodal search, web resource search, image search, text search, and/or application search.

Additionally and/or alternatively, the sensor processing system 160 may include one or more multimodal processing blocks 176, which can be utilized to aid in the processing of multimodal data. The one or more multimodal processing blocks 176 may include generating a multimodal query and/or a multimodal embedding to be processed by one or more machine-learned models and/or one or more search engines 174.

The output(s) of the sensor processing system 160 can then be processed with an output determination system 180 to determine one or more outputs to provide to a user. The output determination system 180 may include heuristic based determinations, machine-learned model based determinations, user selection based determinations, and/or context based determinations.

The output determination system 180 may determine how and/or where to provide the one or more search results in a search results interface 182. Additionally and/or alternatively, the output determination system 180 may determine how and/or where to provide the one or more machine-learned model outputs in a machine-learned model output interface 184. In some implementations, the one or more search results and/or the one or more machine-learned model outputs may be provided for display via one or more user interface elements. The one or more user interface elements may be overlayed over displayed data. For example, one or more detection indicators may be overlaid over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 160 may be utilized to generate and/or provide an augmented-reality experience and/or a virtual-reality experience 186. For example, the one or more obtained datasets may be processed to generate one or more augmented-reality rendering assets and/or one or more virtual-reality rendering assets, which can then be utilized to provide an augmented-reality experience and/or a virtual-reality experience 186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 188 may be determined based on the output(s) of the sensor processing system 160. For example, a search prompt, a purchase prompt, a generate prompt, a reservation prompt, a call prompt, a redirect prompt, and/or one or more other prompts may be determined to be associated with the output(s) of the sensor processing system 160. The one or more action prompts 188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 160 may be processed with one or more generative models 190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 190 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 190 may be stored on-device and/or may be stored on a server computing system. In some implementations, the one or more generative models 190 can perform on-device processing to determine suggested searches, suggested actions, and/or suggested prompts. The one or more generative models 190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 180 may process the one or more datasets and/or the output(s) of the sensor processing system 160 with a data augmentation block 192 to generate augmented data. For example, one or more images can be processed with the data augmentation block 192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 160 may be stored based on a data storage block 194 determination.

The output(s) of the output determination system 180 can then be provided to a user via one or more output components of the user computing device 152. For example, one or more user interface elements associated with the one or more outputs can be provided for display via a visual display of the user computing device 152.

The processes may be performed iteratively and/or continuously. One or more user inputs to the provided user interface elements may condition and/or affect successive processing loops.

FIG. 10 depicts a flowchart of a method 1000 for training one or more machine-learned models according to aspects of the present disclosure. For instance, an example machine-learned model can include a generative model, an object detection model, an optical character recognition model, an object classification model, and/or other machine-learned model.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

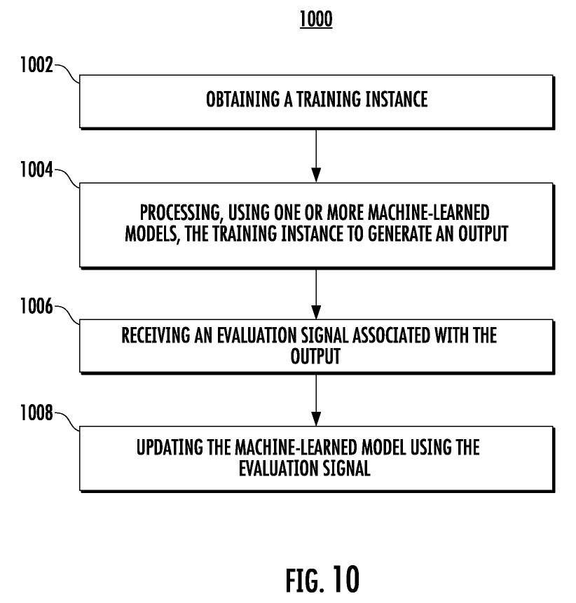

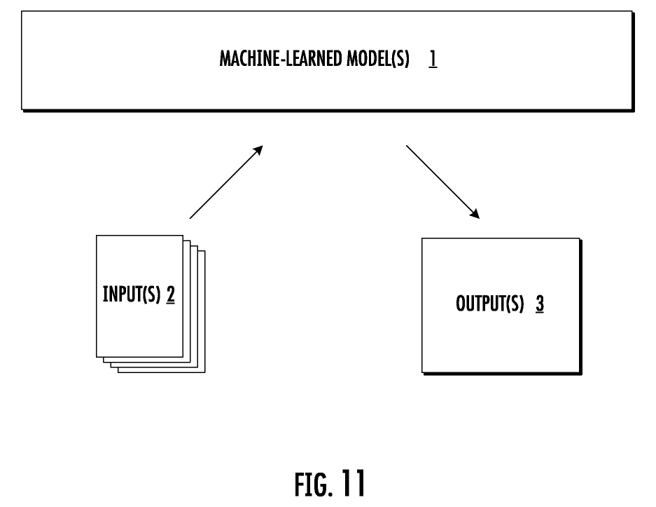

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

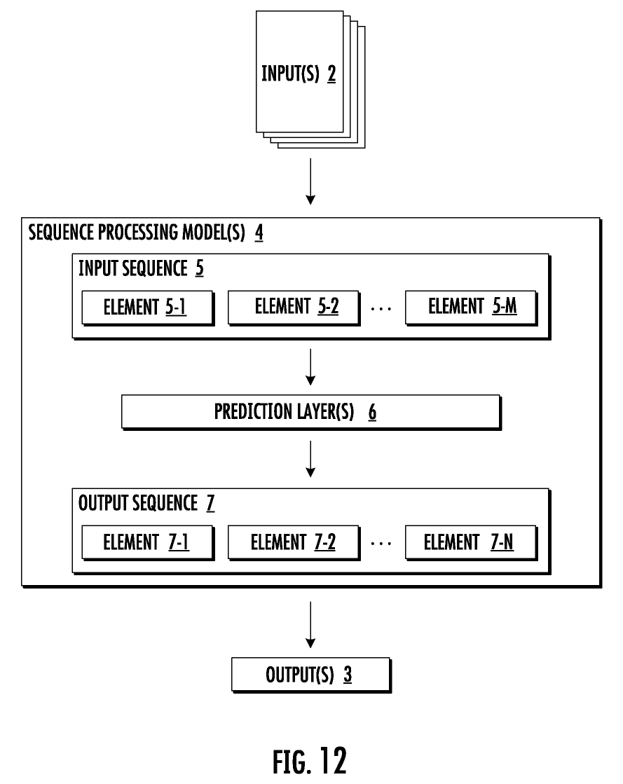

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (Oct. 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

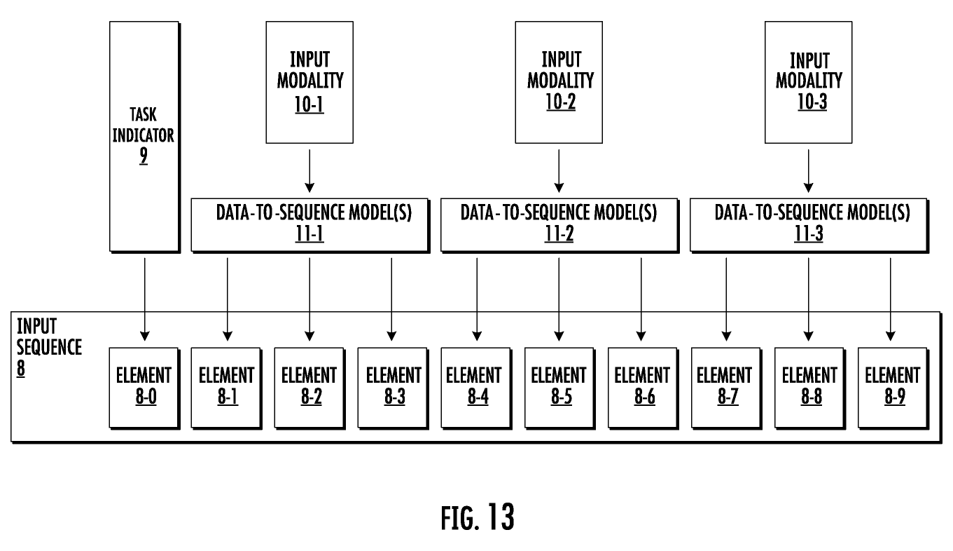

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned embedding within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

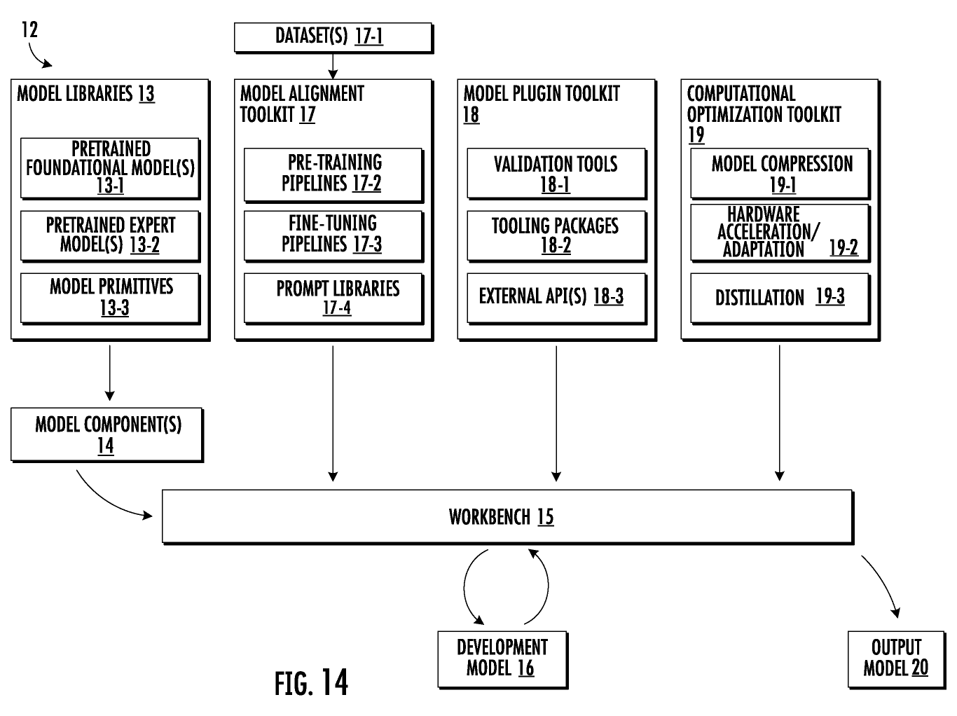

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output and/or input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

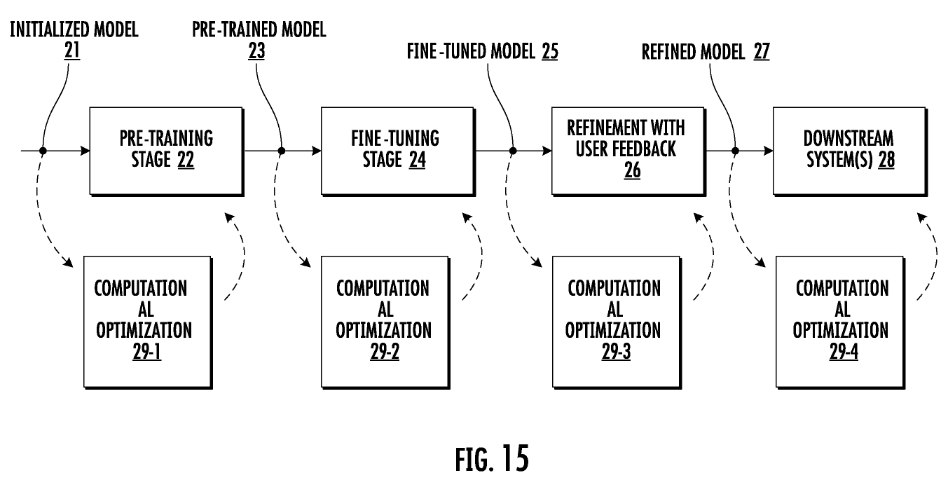

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

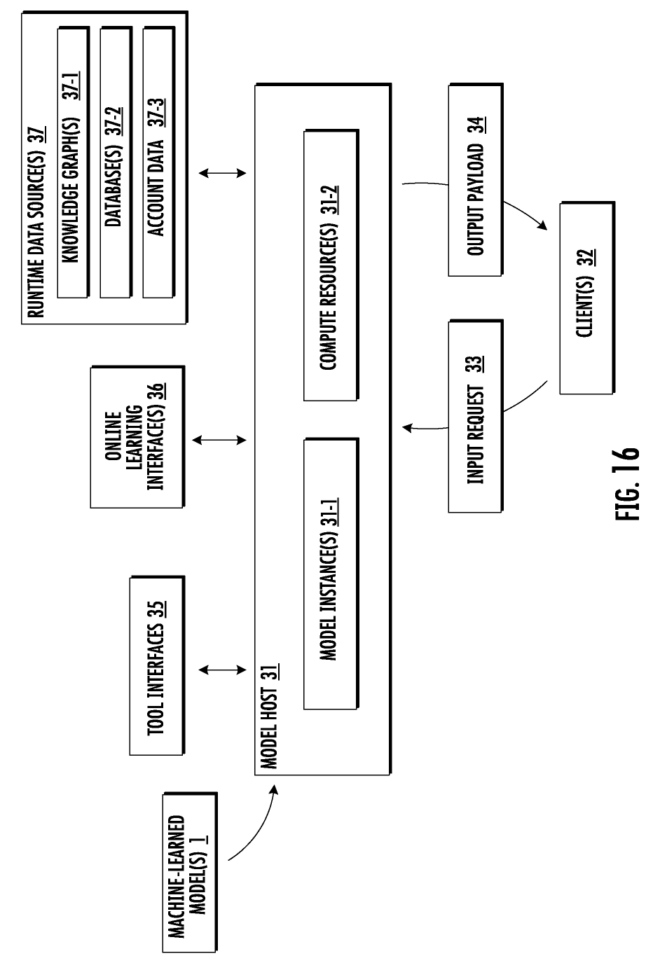

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

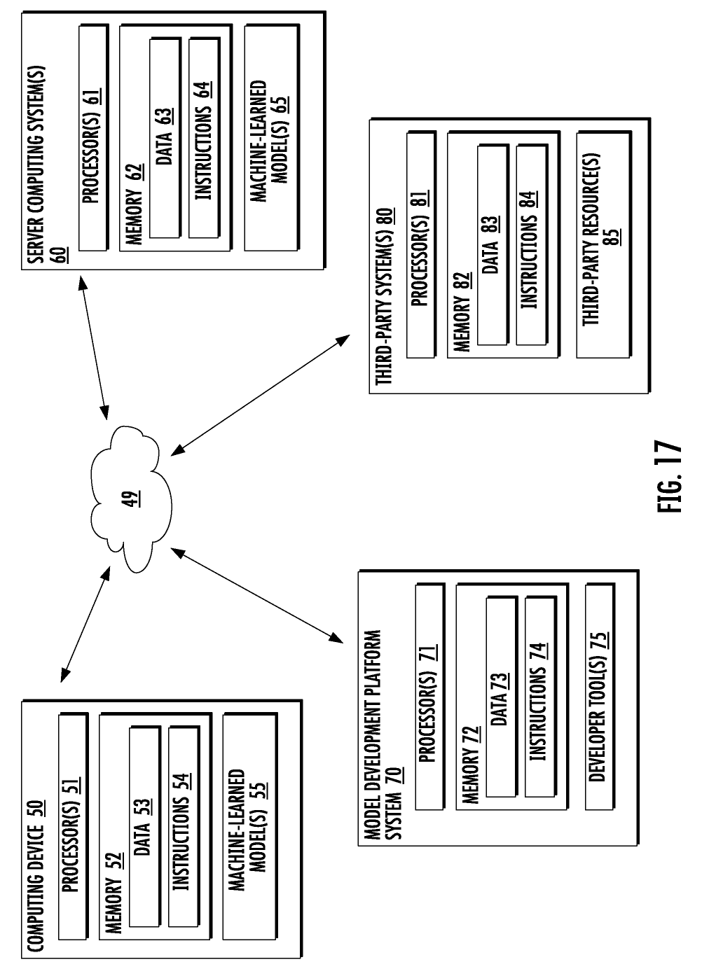

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

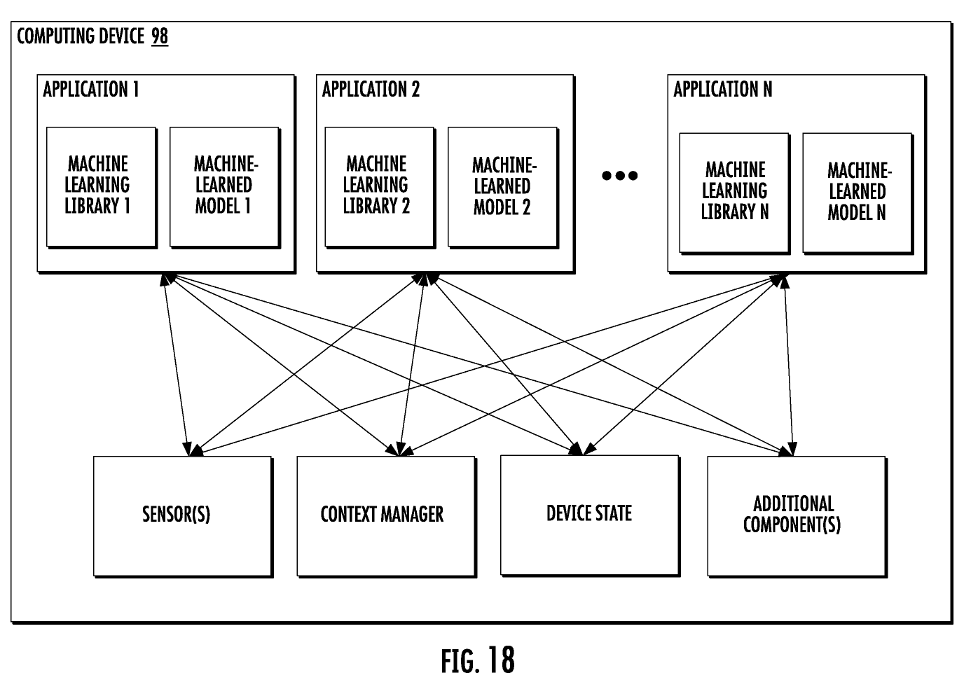

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

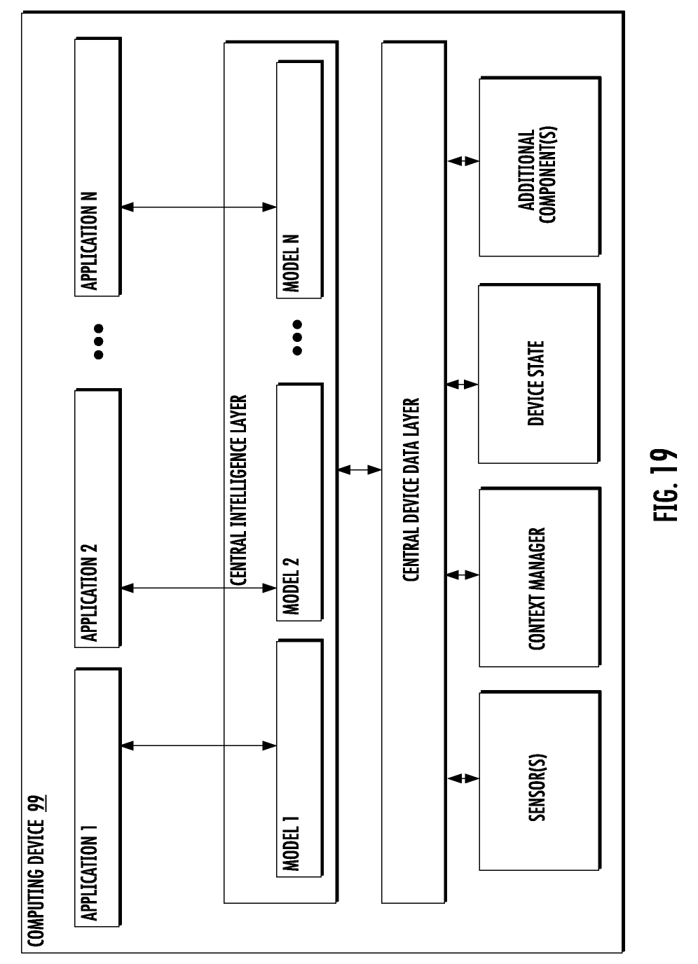

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more processors, a user request to invoke a multimodal chat interface from a user computing device;
obtaining, by the computing system, an image stream from the user computing device, wherein the image stream comprises a plurality of image frames;
obtaining, by the computing system, an audio stream from the user computing device, wherein the audio stream comprises audio data obtained via one or more audio sensors of the user computing device;
processing, by the computing system, at least a portion of the image stream and at least a portion of the audio stream with a generative model to generate a model-generated query;
determining, by the computing system, one or more search results based on the model-generated query;
processing, by the computing system, one or more search results and the model-generated query with the generative model to generate a model-generated response;
providing, by the computing system, the model-generated response via an audio playback of the user computing device.

2. The method of claim 1, further comprising:
providing, by the computing system, a search result notification overlaid over the image stream of the user computing device, wherein the search result notification comprises an indication of the one or more search results.

3. The method of claim 1, further comprising:
before obtaining the user request to invoke the multimodal chat interface:
providing, by the computing system, a voice call interface, wherein the voice call interface is configured to receive audio data via the one or more audio sensors of the user computing device and provide one or more predicted responses for output via at least one of a screen of the user computing device or one or more speakers of the user computing device;
obtaining, by the computing system and via the voice call interface, a voice command, wherein the voice command comprises a unimodal query;
processing, by the computing system, the voice command with the generative model to generate a model-generated predicted response to the unimodal query; and
providing, by the computing system, the model-generated predicted response via the audio playback of the user computing device using the one or more speakers.

4. The method of claim 3, wherein the generative model generates the model-generated predicted response based on one or more information data calls to one or more external tools.

5. The method of claim 1, further comprising:
obtaining, by the computing system, a selection of an interface element of the search result notification; and
providing, by the computing system, a web resource associated with the one or more search results for display, wherein the multimodal chat interface transitions to a voice call interface, wherein transitioning comprises:
stopping image stream collection; and
continuing audio stream collection.

6. The method of claim 1, further comprising:
obtaining, by the computing system, a selection of an interface element of the search result notification; and
providing, by the computing system, a web resource associated with the one or more search results for display, wherein the multimodal chat interface transitions from camera capture to screen capture, wherein transitioning comprises:
stopping image stream collection via one or more image sensors of the user computing device;
beginning screen capture via an overlay interface of the multimodal chat interface; and
continuing audio stream collection.

7. The method of claim 6, further comprising:
obtaining, by the computing system, a follow-up query, wherein the follow-up query is associated with display content on the user computing device;
obtaining, by the computing system, one or more screen capture frames;
processing, by the computing system, the follow-up query and the one or more screen capture frames with the generative model to generate a model-generated follow-up response, wherein the model-generated follow-up response is responsive to the follow-up query; and
providing, by the computing system, the model-generated follow-up response via the audio playback of the user computing device.

8. The method of claim 1, wherein processing, by the computing system, at least the portion of the image stream and at least the portion of the audio stream with the generative model to generate the model-generated query comprises:
processing between three to five minutes of image frames.

9. The method of claim 1, wherein processing, by the computing system, at least the portion of the image stream and at least the portion of the audio stream with the generative model to generate the model-generated query comprises:
variably sampling frames of the image stream.

10. The method of claim 9, wherein a sampling rate of variably sampling is based on performing pixel diffing associated with border pixels of the plurality of image frames.

11. A computing system, the system comprising:
one or more processors; and
one or more non-transitory computer-readable media that collectively store instructions that, when executed by the one or more processors, cause the computing system to perform operations, the operations comprising:
providing a voice call interface, wherein the voice call interface is configured to receive audio data via the one or more audio sensors of a user computing device and provide one or more predicted responses for output via one or more output components of the user computing device, and wherein the voice call interface provides multimodal call options via selectable user interface elements, wherein the multimodal call options comprise:
a viewfinder multimodal chat interface, wherein the viewfinder multimodal chat interface is configured to receive viewfinder image data via one or more image sensors of the user computing device and audio data via the one or more audio sensors of the user computing device and provide one or more predicted responses for output via the one or more output components of the user computing device; and
a screensharing multimodal chat interface, wherein the screensharing multimodal chat interface is configured to receive screen capture image data via a screen capture overlay interface of the user computing device and audio data via the one or more audio sensors of the user computing device and provide one or more predicted responses for output via the one or more output components of the user computing device;
obtaining a selection of a particular multimodal call option associated with the screensharing multimodal chat interface;
obtaining, via the overlay interface, a screen capture stream from the user computing device, wherein the screen capture stream comprises a plurality of image frames descriptive of display content provided for display on the user computing device;
obtaining an audio stream from the user computing device, wherein the audio stream comprises audio data obtained via the one or more audio sensors of the user computing device;
processing at least a portion of the screen capture stream and at least a portion of the audio stream with a generative model to generate a model-generated response; and
providing the model-generated response via an audio playback of the user computing device.

12. The system of claim 11, wherein processing at least the portion of the screen capture stream and at least the portion of the audio stream with the generative model to generate the model-generated response comprises:
processing at least the portion of the screen capture stream and at least the portion of the audio stream with the generative model to generate a model-generated query;
determining one or more search results based on the model-generated query; and
processing one or more search results and the model-generated query with the generative model to generate the model-generated response.

13. The system of claim 11, wherein processing at least the portion of the screen capture stream and at least the portion of the audio stream with the generative model to generate the model-generated response comprises:
processing one or more frames of the plurality of frames to generate a context dataset comprising details associated with features depicted in the one or more frames;
processing at least the portion of the audio stream to generate text data descriptive of the audio data; and
processing the context dataset and the text data with the generative model to generate the model-generated response.

14. The system of claim 13, wherein generating the contextual dataset comprises:
determining a plurality of object labels descriptive of a plurality of objects identified within the one or more frames.

15. The system of claim 13, wherein generating the contextual dataset comprises:
performing optical character recognition on the one or more frames.

16. The system of claim 11, wherein the operations further comprise:
generating a multimodal transcript of a session comprising an audio transcript, search results, and relevant image frames, wherein the audio transcript comprises input voice commands and output model-generated responses, wherein the search results were determined in response to receiving the input voice commands;
storing the multimodal transcript; and
providing the multimodal transcript for display.

17. One or more non-transitory computer-readable media that collectively store instructions that, when executed by one or more computing devices, cause the one or more computing devices to perform operations, the operations comprising:
obtaining a user request to invoke a screensharing multimodal chat interface from a user computing device;
obtaining, via an overlay interface, a screen capture stream from the user computing device, wherein the screen capture stream comprises a plurality of image frames descriptive of display content provided for display on the user computing device;
obtaining an audio stream from the user computing device, wherein the audio stream comprises audio data obtained via one or more audio sensors of the user computing device;
processing at least a portion of the screen capture stream and at least a portion of the audio stream with a generative model to generate a model-generated query;
determining one or more search results based on the model-generated query;
processing one or more search results and the model-generated query with the generative model to generate a model-generated response;
providing the model-generated response via an audio playback of the user computing device; and
providing, during audio playback, an audio output indicator overlaid over a portion of the display content.

18. The one or more non-transitory computer-readable media of claim 17, wherein the overlay interface continues to obtain data descriptive of the screen capture stream during the display of the audio output indicator, and wherein the overlay interface captures the plurality of image frames above a display content interface layer and below an indicator interface layer that displays the audio output indicator to provide for full display content capture even when the audio output indicator is provided for display.

19. The one or more non-transitory computer-readable media of claim 17, wherein the operations further comprise:
processing a frame of the plurality of frames of the screen capture stream to determine the display content is part of a particular web resource;
obtaining a full content item associated with the particular web resource, wherein the full content item comprises the display content; and
wherein at least one of the model-generated query or the model-generated response are determined based on the full content item.

20. The one or more non-transitory computer-readable media of claim 19, wherein obtaining the full content item comprises:
identifying a uniform resource locator associated with the particular web resource; and
at least one of:
obtaining source code data for the particular web resource; or
obtaining a document associated with the particular web resource.
